(19) United States
(12) Patent Application Publication
(10) Pub. No.: US 2023/0122064 A1
(43) Pub. Date: Apr. 20, 2023

(54) Aqueous Coating Composition and Method for Forming Multilayer Coating Film

(71) Applicant: KANSAI PAINT CO., LTD., Hyogo (JP)

(72) Inventor: Takayuki Ryoki, Hiratsuka-shi, Kanagawa (JP)

(21) Appl. No.: 17/904,948

(22) PCT Filed: Nov. 2, 2020
(86) PCT No.: PCT/JP2020/041128

§ 371 Date: Aug. 24, 2022

(30) Foreign Application Priority Data
Feb. 27, 2020 (JP) 2020-031167

(51) Int. Cl. C09D 175/08; C08J 7/02; C08J 7/04; C08J 7/043

(52) U.S. Cl. CPC C09D 175/08; C08J 7/02; C08J 7/042; C08J 7/043; C08J 2333/08; C08J 2375/08

(57) ABSTRACT

The present invention relates to an aqueous coating composition which has excellent storage stability, while being capable of forming a coating film that exhibits excellent chipping resistance and excellent finish appearance in a dust part and in a film formation part. The present invention provides an aqueous coating composition which contains (A) a urethane resin that is obtained from constituents including (a1) a polyisocyanate component and (a2) a polyol component containing (a2-1) a polyether polyol and (a2-2) a polycarbonate polyol, (B) at least one hydroxyl group-containing resin that is selected from among (B1) hydroxyl group-containing acrylic resins and (B2) hydroxyl group-containing polyester resins, (C) an organic solvent that has a solubility parameter within the range of from 8.8 to 10.1, and (D) water, wherein based on 100 parts by mass of the resin solid content in the aqueous coating composition, the content of the urethan resin (A) is within the range of from 60 to 85 parts by mass and the content of the organic solvent (C) is within the range of from 5 to 30 parts by mass.

### FIELD

The invention relates to an aqueous coating composition and to a method for forming a multilayer coating film.

### BACKGROUND

When an automobile travels at high speed, gravel impacts with the painted surface of the outer plate of the automobile body, creating the phenomenon of chipping in which the coating film detaches at the impacted sections. When chipping occurs, the outer appearance of the automobile is impaired and serious problems also result as the steel sheet under the coating film is exposed at the detached sections, leading to rust and promoting corrosion. Impact of gravel while an automobile travels generally takes place at suspension sections such as wheel wells, and on the hood tops and roof tops, making the chipping phenomenon more likely to occur at those sections.

Automobiles are therefore partially painted with chipping-resistant coating compositions at such sections that are prone to chipping. However, since chipping-resistant coating compositions are only partially coated, coating results in formation of dust-like coating near the boundaries between the sections coated and not coated with the chipping-resistant coating composition, resulting in an incompletely formed film at those sections. Such chipping-resistant coating compositions therefore must enable coating films having an excellent outer appearance to be formed not only on the film-formed sections but also on sections that are coated in a dust-like manner (hereunder also referred to as “dust sections”).

PTL 1 describes a chipping-resistant coating composition comprising calcium carbonate in the form of whiskers having a long diameter of 3 to 50 μm, a short diameter of 0.3 to 2.0 μm and an aspect ratio (long diameter/short diameter) of 5 to 50, the composition allowing formation of a coating film with excellent chipping resistance. However, multilayer coating films formed using the chipping-resistant coating composition have had inadequate finished appearance at dust sections and film-formed sections, and chipping resistance.

PTL 2 describes a chipping-resistant aqueous coating composition composed mainly of (a) an aqueous ethylene copolymer resin, being an aqueous copolymer resin composed mainly of ethylene and an ethylenic unsaturated monomer with a carboxyl group wherein at least some of the carboxyl groups are bonded to the main chain and the carboxyl group content is at least 10 wt % of the copolymer resin, and (b) an aqueous polyurethane resin, wherein the mixing ratio of component (a) and component (b) is 15/85 to 50/50 as the mass ratio of [(a)/(b)], the adhesion and adhesiveness between the (coating film) layers being satisfactory, and the composition exhibiting satisfactory chipping resistance unlike existing chipping primers. However, multilayer coating films formed using the chipping-resistant aqueous coating composition have had inadequate finished appearance at dust sections and film-formed sections.

In addition, since it becomes difficult to perform application using a stored coating composition when the coating composition undergoes thickening or settling during storage, greater storage stability is also being required for coating compositions.

### CITATION LIST

### Patent Literature

[PTL 1] Japanese Unexamined Patent Publication HEI No. 11-323193
[PTL 2] Japanese Unexamined Patent Publication HEI No. 6-9925

### SUMMARY

### Technical Problem

It is an object of the present invention to provide an aqueous coating composition with excellent storage stability, that is able to form coated films with excellent finished appearance at dust sections and film-formed sections, and chipping resistance.

### Solution to Problem

As a result of avid research with the goal of achieving the aforestated object, the present inventors have found that the object can be achieved by an aqueous coating composition that includes (A) a urethane resin obtained from constituent components including (a1) a polyisocyanate component and (a2) a polyol component comprising (a2-1) a polyether polyol and (a2-2) a polycarbonate polyol, (B) one or more hydroxyl group-containing resins selected from among (B1) hydroxyl group-containing acrylic resins and (B2) hydroxyl group-containing polyester resins, (C) an organic solvent with a solubility parameter in the range of 8.8 to 10.1 and (D) water, wherein the content of the urethane resin (A) is in the range of 60 to 85 parts by mass and the content of the organic solvent (C) is in the range of 5 to 30 parts by mass, based on 100 parts by mass as the resin solid content of the aqueous coating composition.

According to the invention it is possible to provide an aqueous coating composition and a method for forming a multilayer coating film, encompassing the following aspects.

1. An aqueous coating composition that includes:
(A) a urethane resin obtained from constituent components including (a1) a polyisocyanate component and (a2) a polyol component comprising (a2-1) a polyether polyol and (a2-2) a polycarbonate polyol,
(B) one or more hydroxyl group-containing resins selected from among (B1) hydroxyl group-containing acrylic resins and (B2) hydroxyl group-containing polyester resins,

(C) an organic solvent with a solubility parameter in the range of 8.8 to 10.1 and (D) water, wherein:
the content of the urethane resin (A) is in the range of 60 to 85 parts by mass and
the content of the organic solvent (C) is in the range of 5 to 30 parts by mass, based on 100 parts by mass as the resin solid content of the aqueous coating composition.

2. The aqueous coating composition according to 1, wherein the ratio of the polyether polyol (a2-1) and the polycarbonate polyol (a2-2) in the polyol component (a2) is 80/20 to 30/70, as the mass ratio of polyether polyol (a2-1)/polycarbonate polyol (a2-2).

3. The aqueous coating composition according to 1. or 2, wherein the solubility parameter of the organic solvent (C) is in the range of 8.9 to 9.7.

4. The aqueous coating composition according to any one of 1. to 3, further comprising a curing agent (E).

5. The aqueous coating composition according to 4, wherein the curing agent (E) is at least one selected from among melamine resins (E1) and blocked polyisocyanate compounds (E3).

6. A method for forming a multilayer coating film, which includes:
step (M1-1): a step of applying an aqueous coating composition according to any one of 1. to 5. onto an article to be coated to form a chipping primer coating film,
step (M1-2): a step of applying an aqueous intermediate coating composition onto the chipping primer coating film formed in step (M1-1) to form an intermediate coating film,
step (M1-3): a step of applying a base coating composition onto the intermediate coating film formed in step (M1-2) to form a base coating film,
step (M1-4): a step of applying a clear coating composition onto the base coating film formed in step (M1-3) to form a clear coating film, and
step (M1-5): a step of heat curing the chipping primer coating film, intermediate coating film, base coating film and clear coating film formed in steps (M1-1) to (M1-4) all at once.

7. A method for forming a multilayer coating film, which includes:
step (M2-1): a step of applying an aqueous coating composition according to any one of 1. to 5. onto an article to be coated to form a chipping primer coating film,
step (M2-2): a step of applying an aqueous intermediate coating composition onto the chipping primer coating film formed in step (M2-1) to form an intermediate coating film,
step (M2-3): a step of heat curing the chipping primer coating film and intermediate coating film formed in steps (M2-1) and (M2-2) all at once,
step (M2-4): a step of applying a base coating composition onto the intermediate coating film cured in step (M2-3) to form a base coating film,
step (M2-5): a step of applying a clear coating composition onto the base coating film formed in step (M2-4) to form a clear coating film, and
step (M2-6): a step of heat curing the base coating film and clear coating film formed in steps (M2-4) and (M2-5) all at once.

### Advantageous Effects of Invention

The aqueous coating composition of the invention has excellent storage stability and is able to form coated films with excellent finished appearance at dust sections and film-formed sections, and chipping resistance.

### DESCRIPTION OF EMBODIMENTS

The aqueous coating composition of the invention (hereunder also referred to simply as “the present coating material”) will now be described in detail.

The aqueous coating composition of the invention is an aqueous coating composition including: (A) a urethane resin obtained from constituent components including (a1) a polyisocyanate component and (a2) a polyol component comprising (a2-1) a polyether polyol and (a2-2) a polycarbonate polyol, (B) one or more hydroxyl group-containing resins selected from among (B1) hydroxyl group-containing acrylic resins and (B2) hydroxyl group-containing polyester resins, (C) an organic solvent with a solubility parameter in the range of 8.8 to 10.1 and (D) water, wherein the content of the urethane resin (A) is in the range of 60 to 85 parts by mass and the content of the organic solvent (C) is in the range of 5 to 30 parts by mass, based on 100 parts by mass as the resin solid content of the aqueous coating composition.

For the present purpose, “aqueous coating material” is a term used in contrast to “organic solvent-based coating material”, and generally refers to a coating material having a coating film-forming resin or pigment dispersed and/or dissolved in water or a medium composed mainly of water (an aqueous medium). An organic solvent-based coating material is a coating material wherein the solvent used contains substantially no water, or wherein all or virtually all of the solvent used is an organic solvent.

### Urethane Resin (A)

The urethane resin (A) is a urethane resin obtained from constituent components that include a polyisocyanate component (a1) and a polyol component (a2) comprising a polyether polyol (a2-1) and a polycarbonate polyol (a2-2). In other words, the urethane resin (A) is the reaction product of a polyisocyanate component (a1) and a polyol component (a2) comprising a polyether polyol (a2-1) and a polycarbonate polyol (a2-2).

The urethane resin (A) can be synthesized using a polyisocyanate component (a1), a polyol component (a2) comprising a polyether polyol (a2-1) and a polycarbonate polyol (a2-2), and if necessary a compound having both an active hydrogen group and an ion-forming group, as a component to provide a water dispersion group.

### Polyisocyanate Component (a1)

The polyisocyanate component (a1) is a compound having two or more isocyanate groups in the molecule.

Examples for the polyisocyanate component (a1) include aliphatic polyisocyanates such as hexamethylene diisocyanate, trimethylhexamethylene diisocyanate, dimer acid diisocyanate and lysine diisocyanate, as well as biuret type adducts and isocyanurate ring adducts of these polyisocyanates; alicyclic diisocyanates such as isophorone diisocyanate, 4,4′-methylenebis(cyclohexylisocyanate) (common name: hydrogenated MDI), methylcyclohexane-2,4- (or -2,6-)diisocyanate, 1,3- (or 1,4-)di(isocyanatomethyl)cyclohexane, 1,4-cyclohexane diisocyanate, 1,3-cyclopentane diisocyanate and 1,2-cyclohexane diisocyanate, as well as biuret type adducts and isocyanurate ring adducts of these polyisocyanates; aromatic diisocyanate compounds such as xylylene diisocyanate, meta-xylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4-toluidine diisocyanate, 4,4′-diphenyl ether diisocyanate, (m- or p-)phenylene diisocyanate, 4,4′-biphenylene diisocyanate, 3,3′-dimethyl-4,4′-biphenylene diisocyanate, bis(4-isocyanatophenyl)sulfone, isopropylidene bis(4-phenylisocyanate), as well as biuret type adducts and isocyanurate ring adducts of these polyisocyanates; and polyisocyanates having 3 or more isocyanate groups in the molecule, such as triphenylmethane-4,4′,4″-triisocyanate, 1,3,5-triisocyanatobenzene, 2,4,6-triisocyanatotoluene and 4,4′-dimethyldiphenylmethane-2,2′,5,5′-tetraisocyanate, as well as biuret type adducts and isocyanurate ring adducts of these polyisocyanates.

### Polyol Component (a2)

The polyol component (a2) is a compound having 2 or more hydroxyl groups in the molecule, and it comprises a polyether polyol (a2-1) and a polycarbonate polyol (a2-2).

Polyether Polyol (a2-1)

Examples of polyether polyols include alkylene oxide addition products of low-molecular-weight polyols such as ethylene glycol, propylene glycol, diethylene glycol, triethylene glycol, 1,2-butylene glycol, 1,3-butylene glycol, 2,3-butylene glycol, 1,4-butylene glycol, 1,5-pentanediol, neopentyl glycol, 1,6-hexaneglycol, 2,5-hexanediol, dipropylene glycol, 2,2,4-trimethyl-1,3-pentanediol, tricyclodecanedimethanol and 1,4-cyclohexanedimethanol, and ring-opening (co)polymers of alkylene oxides or cyclic ethers (such as tetrahydrofuran). Specific examples include polyethylene glycol, polypropylene glycol, ethylene glycol-propylene glycol (block or random) copolymer, polytetramethylene glycol, polyhexamethylene glycol and polyoctamethylene glycol.

The polyether polyol (a2-1) used is preferably polyethylene glycol, polypropylene glycol or polytetramethylene glycol. From the viewpoint of productivity and flexibility of the formed coating film, the number-average molecular weight of the polyether polyol (a2-1) is preferably 500 to 10,000, more preferably 1000 to 5000 and even more preferably 1600 to 4000.

The polyether polyol (a2-1) used may be a single type alone, or a combination of two or more types.

Polycarbonate Polyol (a2-2)

Examples for the polycarbonate polyol (a2-2) that may be used include compounds represented by the following general formula:

HO—R—(O—C(O)—O—R)ₓ—OH

(where R represents a C₁₋₁₂ alkylene or C₁₋₃ alkylene-C₃₋₈ cycloalkylene-C₁₋₃ alkylene group, x represents the number of repeating units of molecules, usually an integer of 5 to 50, and multiple R groups may be the same or different). These compounds can be obtained by ester-exchange in which a polyol and a substituted carbonate (such as diethyl carbonate or diphenyl carbonate) are reacted under conditions with an excess of hydroxyl groups, or a method of reacting the saturated aliphatic polyol with phosgene, and if necessary further subsequently reacting it with a saturated aliphatic polyol.

A C₁₋₁₂ alkylene group (saturated aliphatic polyol residue) represented by R may be a straight-chain or branched (preferably straight-chain) alkylene group of 1 to 12 carbon atoms, examples of which include —CH₂—, —(CH₂)₂—, —(CH₂)₃—, —(CH₂)₄—, —CH₂—CH(CH₃)—CH₂—, —(CH₂)₅—, —CH₂—CH(C₂H₅)—CH₂—, —(CH₂)₆—, —(CH₂)₇—, —(CH₂)₈—, —(CH₂)₉—, —(CH₂)₁₀—, —(CH₂)₁₁—and —(CH₂)₁₂.

The C₁₋₃ alkylene group in the “C₁₋₃ alkylene-C₃₋₈ cycloalkylene-C₁₋₃ alkylene group” represented by R represents a straight-chain or branched (preferably straight-chain) alkylene group of 1 to 3 carbon atoms (preferably 1), and methylene, ethylene and propylene groups (n-propylene and isopropylene groups) may be mentioned.

The two “C₁₋₃ alkylene” groups in the “C₁₋₃ alkylene-C₃₋₈ cycloalkylene-C₁₋₃ alkylene group” may be the same or different (and are preferably the same).

The C₃₋₈ cycloalkylene group in the “C₁₋₃ alkylene-C₃₋₈ cycloalkylene-C₁₋₃ alkylene group” represents a divalent hydrocarbon group that can be derived by removing two hydrogen atoms from a cycloalkane of 3 to 8 carbon atoms (preferably 5 to 7 carbon atoms and more preferably 6 carbon atoms), and examples include 1,1-cyclopropylene group, 1,2-cyclopropylene group, 1,1-cyclobutylene group, 1,2-cyclobutylene group, 1,3-cyclobutylene group, 1,2-cyclopentylene group, 1,3-cyclopentylene group, 1,1-cyclohexylene group, 1,2-cyclohexylene group, 1,3-cyclohexylene group, 1,4-cyclohexylene group, 1,3-cycloheptylene group and 1,4-cyclooctylene group.

The C₁₋₃ alkylene-C₃₋₈ cycloalkylene-C₁₋₃ alkylene group may be a divalent substituent comprising the aforementioned C₁₋₃ alkylene, C₃₋₈ cycloalkylene and C₁₋₃ alkylene groups bonded in that order, and more specific examples include methylene-1,2-cyclopropylene-methylene group, methylene-1,2-cyclopropylene-ethylene group, ethylene-1,2-cyclopropylene-ethylene group, methylene-1,3-cyclobutylene-methylene group, methylene-1,3-cyclopentylene-methylene group, methylene-1,1-cyclohexylene-methylene group, methylene-1,3-cyclohexylene-methylene group, methylene-1,4-cyclohexylene-methylene group, ethylene-1,4-cyclohexylene-ethylene group, methylene-1,4-cyclohexylene-ethylene group, propylene-1,4-cyclohexylene-propylene group, methylene-1,3-cycloheptylene-methylene group and methylene-1,4-cyclooctylene-methylene group.

From the viewpoint of productivity and the physical properties of the obtained coating film, the R of the polycarbonate polyol (a2-2) is preferably a saturated aliphatic polyol residue of 1 to 12 carbon atoms and more preferably a saturated aliphatic polyol residue of 4 to 10 carbon atoms. From the viewpoint of productivity, the number-average molecular weight of the polycarbonate polyol (a2-2) is preferably 500 to 10,000, more preferably 1000 to 5000 and even more preferably 1600 to 4000. These polycarbonate polyol (a2-2) compounds may be used alone or in combinations of two or more.

From the viewpoint of storage stability of the aqueous coating composition of the invention and chipping resistance and finished appearance of the formed coating film, the total content of the polyether polyol (a2-1) and polycarbonate polyol (a2-2) is preferably in the range of 30 to 100 mass %, more preferably 50 to 100 mass % and even more preferably 70 to 100 mass %, based on the total solid content of the polyol component (a2).

From the viewpoint of the storage stability of the aqueous coating composition of the invention and the chipping resistance and finished appearance of the formed coating film, the ratio of the polyether polyol (a2-1) with respect to the polycarbonate polyol (a2-2) in the polyol component (a2) is preferably 80/20 to 30/70, more preferably 75/25 to 40/60 and even more preferably 70/30 to 50/50, as the mass ratio of polyether polyol (a2-1)/polycarbonate polyol (a2-2).

If necessary, the polyol component (a2) may also include other polyol components, examples of which include low-molecular-weight polyols such as ethylene glycol, propylene glycol, diethylene glycol, triethylene glycol, 1,2-butylene glycol, 1,3-butylene glycol, 2,3-butylene glycol, 1,4-butylene glycol, 1,5-pentanediol, neopentyl glycol, 1,6-hexaneglycol, 2,5-hexanediol, dipropylene glycol, 2,2,4-trimethyl-1,3-pentanediol, tricyclodecanedimethanol and 1,4-cyclohexanedimethanol.

Examples of high-molecular-weight polyols that may be used include polyester polyols and polyether ester polyols.

The polyester polyol can be one obtained by polycondensation of a dicarboxylic acid (anhydride) such as adipic acid, succinic acid, sebacic acid, glutaric acid, maleic acid, fumaric acid or phthalic acid, with a low-molecular-weight polyol such as ethylene glycol, propylene glycol, 1,4-butanediol, 1,6-hexanediol, 1,8-octamethylenediol or neopentyl glycol, under conditions with an excess of hydroxyl groups. Specific examples include ethylene glycol-adipic acid condensate, butanediol-adipic acid condensate, hexamethylene glycol-adipic acid condensate, ethylene glycol-propylene glycol-adipic acid condensate or a polylactone polyol obtained by ring-opening polymerization of a lactone with glycol as the initiator.

The polyether ester polyol may be one obtained by adding an ether group-containing polyol (such as a polyether polyol (a2-1) or diethylene glycol) or a mixture thereof with another glycol, to a dicarboxylic acid (anhydride) mentioned for the polyester polyol, and reacting them with the alkylene oxide, an example of which is polytetramethylene glycol-adipic acid condensate.

Compounds having both an active hydrogen group and an ion-forming group include compounds with two or more hydroxyl groups and one or more carboxyl groups in the molecule, compounds with two or more hydroxyl groups and one or more sulfonic acid groups in the molecule, and compounds having two or more amino groups and one or more carboxyl groups in the molecule, any of which may be used alone or in combinations of two or more.

Preferred as compounds having both an active hydrogen group and an ion-forming group are compounds with two or more hydroxyl groups and one or more carboxyl groups in the molecule and compounds with two or more hydroxyl groups and one or more sulfonic acid groups in the molecule. According to the invention, compounds having both two or more hydroxyl groups and an ion-forming group, such as compounds with two or more hydroxyl groups and one or more carboxyl groups in the molecule and compounds with two or more hydroxyl groups and one or more sulfonic acid groups in the molecule, are encompassed by the polyol component (a2).

Examples of compounds with two or more hydroxyl groups and one or more carboxyl groups in the molecule include alkanolcarboxylic acid compounds such as dimethylolpropionic acid, dimethylolacetic acid, dimethylolbutanoic acid, dimethylolheptanoic acid, dimethylolnonanoic acid, 1-carboxy-1,5-pentylenediamine, dihydroxybenzoic acid and 3,5-diaminobenzoic acid, and half ester compounds comprising polyoxypropylenetriol and maleic anhydride and/or phthalic anhydride.

Examples of compounds with two or more hydroxyl groups and one or more sulfonic acid groups in the molecule include 2-sulfonic acid-1,4-butanediol, 5-sulfonic acid-di-β-hydroxyethyl isophthalate and N,N-bis(2-hydroxyethyl)aminoethylsulfonic acid.

From the viewpoint of flexibility of the obtained coating film, the compounds having both an active hydrogen group and an ion-forming group are most preferably compounds with two or more hydroxyl groups and one or more carboxyl groups in the molecule.

A compound having both an active hydrogen group and an ion-forming group acts as an ion-forming group in the urethane resin (A). Such a compound is preferably used from the viewpoint of the dispersion stability of the urethane resin (A).

When a compound having both an active hydrogen group and an ion-forming group is used, it is used in an amount preferably in the range of 1 to 10 mass %, more preferably in the range of 1 to 7 mass % and even more preferably in the range of 1 to 5 mass % with respect to the total amount of the compounds composing the urethane resin (A), from the viewpoint of aqueous dispersion stability and the water resistance of the formed coating film.

The urethane resin (A) of the invention will usually be synthesized as a dispersion in an aqueous solvent, and the form of the urethane resin (A) is not particularly restricted so long as they are dispersed in an aqueous solvent. An “aqueous solvent” is a solvent composed mainly of water (such as a solvent comprising 90 to 100 mass % water).

The method of producing the urethane resin (A) is not particularly restricted, and any conventionally known method may be employed. An example for the production method is a method in which urethanation reaction is carried out between the polyisocyanate component (a1) and the polyol component (a2), or if necessary a compound having both an active hydrogen group and an ion-forming group is used in urethanation reaction, in an organic solvent to synthesize a prepolymer, and the obtained prepolymer is emulsified, if necessary with subsequent chain extension reaction and solvent removal.

A catalyst may also be used if necessary for the urethanation reaction between the polyisocyanate component (a1) and polyol component (a2).

Examples of catalysts include bismuth carboxylate compounds such as bismuth(III) tris(2-ethylhexanoate; organic tin compounds such as dibutyltin dilaurate, dibutyltin dioctoate and stannous octoate; and tertiary amine compounds such as triethylamine and triethylenediamine.

From the viewpoint of environmental adaptability, bismuth-based catalysts are preferred for their relatively low toxicity.

The urethanation reaction is preferably carried out at 50 to 120° C.

A prepolymer of the urethane resin (A) is obtained in this manner.

The organic solvent used for synthesis of the prepolymer may be an organic solvent that is inert to isocyanates and does not interfere with the urethanation reaction, examples of such organic solvents including aromatic hydrocarbon-based solvents such as toluene and xylene, ester-based solvents such as ethyl acetate and butyl acetate and ketone-based solvents such as acetone and methyl ethyl ketone. Preferred for use among these are ketone-based solvents and ester-based solvents, from the viewpoint of aqueous dispersion stability.

A neutralizer for the ion-forming groups and deionized water may also be added to the urethane prepolymer if necessary, for aqueous dispersion (emulsification), and chain extension reaction and solvent removal may also be carried out as necessary, to obtain an aqueous dispersion of the urethane resin (A).

Neutralizers are not particularly restricted so long as they can neutralize the ion-forming groups, and examples of basic compounds for neutralization include organic amines such as ammonia, diethylamine, ethylethanolamine, diethanolamine, triethanolamine, monoethanolamine, monopropanolamine, isopropanolamine, ethylaminoethylamine, hydroxyethylamine, triethylamine, tributylamine, dimethylethanolamine and diethylenetriamine; or alkali metal hydroxides such as sodium hydroxide and potassium hydroxide. Any of these neutralizers may be used alone or in combinations of two or more.

Organic amines are preferred among these basic compounds from the viewpoint of the water resistance of the coated film obtained by application to the coating composition.

These neutralizing agents are preferably used in amounts such that the final pH of the aqueous dispersion of the urethane resin (A) is about 6.0 to 9.0.

When a neutralizer is added, the amount of neutralizer added is 0.1 to 1.5 equivalents and preferably 0.3 to 1.2 equivalents with respect to the acid groups such as carboxyl groups.

The method for obtaining the aqueous dispersion may be dispersion with a common stirrer, but a homomixer, homogenizer, Disper mixer or line mixer may also be used in order to obtain a homogeneous aqueous dispersion with a narrower particle size.

For chain extension reaction (high molecularization) of the urethane prepolymer, a chain extender other than water may be added as necessary for reaction between the urethane prepolymer and the chain extender. The chain extender used may be a publicly known chain extender having active hydrogen. Specific examples include diamine compounds such as ethylenediamine, hexamethylenediamine, cyclohexanediamine, cyclohexylmethanediamine and isophoronediamine, triamine compounds such as diethylenetriamine, and hydrazine.

From the viewpoint of increasing the degree of chain extension, it is preferred to use a trifunctional or greater amine compound, which may be a triamine compound such as diethylenetriamine. From the viewpoint of the flexibility of the obtained coating film it is preferred to use a diamine compound such as ethylenediamine.

For introduction of a reactive functional group it is also preferred to use a compound having one or more each of amines and hydroxyl groups in each molecule, such as hydroxyethylaminoethylamine.

From the viewpoint of productivity, the content ratio of the polyisocyanate component (a1) and polyol component (a2) of the urethane resin (A) is preferably 1/1.01 to 1/3.0 and more preferably 1/1.05 to 1/2.0, as the molar ratio of active hydrogen groups of polyol component (a2)/isocyanate groups of polyisocyanate component (a1).

The number-average molecular weight of the urethane resin (A) is preferably in the range of 10,000 or higher, especially 50,000 or higher and most especially 100,000 or higher, from the viewpoint of dispersibility, productivity, and performance of the obtained coating film.

A number-average molecular weight of 10,000 or higher will result in satisfactory coating film performance.

From the viewpoint of dispersibility and storage stability, the aqueous dispersion of the urethane resin (A) may have a mean particle size of generally in the range of 10 to 5000 nm, preferably 10 to 1000 nm, even more preferably 20 to 500 nm and most preferably 50 to 300 nm.

As used herein, the mean particle diameter of the aqueous dispersion of the urethane resin (A) is the value measured using a submicron particle size distribution analyzer at 20° C., after dilution with deionized water by a common method. As an example of a submicron particle size distribution analyzer, there may be used a “COULTER N4” (trade name of Beckman Coulter, Inc.).

From the viewpoint of aqueous dispersion stability and water resistance of the obtained coating film, the urethane resin (A) preferably has an acid value of 5 to 40 mgKOH/g, especially 5 to 30 mgKOH/g and most especially 10 to 30 mgKOH/g.

From the viewpoint of water resistance of the obtained coating film, the urethane resin (A) preferably has a hydroxyl value of 0 to 100 mgKOH/g, especially 0 to 50 mgKOH/g and most especially 0 to 10 mgKOH/g.

The solid concentration of the urethane resin (A) in aqueous dispersion is preferably 20 to 50 mass % and more preferably in the range of 30 to 50 mass %. If the solid concentration is 50 mass % or lower then emulsification will be facilitated and it will be possible to more easily obtain an aqueous dispersion. If the solid concentration is 20 mass % or higher, the solvent component will be reduced and the solid content of the aqueous coating composition can thus be increased.

The content of the urethane resin (A) is in the range of 60 to 85 parts by mass based on 100 parts by mass of resin solid content in the aqueous coating composition. From the viewpoint of storage stability of the aqueous coating composition of the invention, and chipping resistance and finished appearance of the formed coating film, the content of the urethane resin (A) is preferably in the range of 65 to 85 parts by mass and more preferably in the range of 70 to 85 parts by mass.

### Hydroxyl Group-Containing Resin (B)

The hydroxyl group-containing resin (B) is at least one hydroxyl group-containing resin selected from among hydroxyl group-containing acrylic resins (B1) and hydroxyl group-containing polyester resins (B2).

### Hydroxyl Group-Containing Acrylic Resin (B1)

The hydroxyl group-containing acrylic resin (B1) used may be a water-soluble or water-dispersible acrylic resin which is conventionally known for use in aqueous coating materials.

The hydroxyl group-containing acrylic resin (B1) can be produced, for example, by copolymerizing a hydroxyl group-containing polymerizable unsaturated monomer and another polymerizable unsaturated monomer that is copolymerizable with the hydroxyl group-containing polymerizable unsaturated monomer, by a known method such as a solution polymerization method in an organic solvent or an emulsion polymerization method in water.

The hydroxyl group-containing polymerizable unsaturated monomer is a compound having one or more hydroxyl groups and polymerizable unsaturated bonds in the molecule. Specific examples for the hydroxyl group-containing polymerizable unsaturated monomer include monoesterified products of (meth)acrylic acid and dihydric alcohols of 2 to 8 carbon atoms, such as 2-hydroxyethyl (meth)acrylate, 2-hydroxypropyl (meth)acrylate, 3-hydroxypropyl (meth)acrylate and 4-hydroxybutyl (meth)acrylate; 8-caprolactone-modified forms of the monoesterified products of (meth)acrylic acid and dihydric alcohols of 2 to 8 carbon atoms; N-hydroxymethyl (meth)acrylamide; and allyl alcohols; as well as (meth)acrylates having polyoxyethylene chains with hydroxyl groups at the molecular ends. However, monomers qualifying as (xvii) polymerizable unsaturated monomers with ultraviolet absorbing functional groups as mentioned below are to be defined as other polymerizable unsaturated monomers that are copolymerizable with the hydroxyl group-containing polymerizable unsaturated monomers, and are excluded from the hydroxyl group-containing polymerizable unsaturated monomers for the invention, even if they are hydroxyl group-containing monomers. These may be used either alone or in combinations of two or more.

Examples of other polymerizable unsaturated monomers that are copolymerizable with the hydroxyl group-containing polymerizable unsaturated monomer and that may be used include the following monomers (i) to (xx). These polymerizable unsaturated monomers may be used alone or in combinations of two or more.

(i) Alkyl or cycloalkyl (meth)acrylates: For example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, n-octyl (meth)acrylate, 2-ethylhexyl (meth)acrylate, nonyl (meth)acrylate, tridecyl (meth)acrylate, lauryl (meth)acrylate, stearyl (meth)acrylate, isostearyl (meth)acrylate, cyclohexyl (meth)acrylate, methylcyclohexyl (meth)acrylate, t-butylcyclohexyl (meth)acrylate, cyclododecyl (meth)acrylate, tricyclodecanyl (meth)acrylate and the like.

(ii) Polymerizable unsaturated monomers with isobornyl groups: Monomers such as isobornyl (meth)acrylate.

(iii) Polymerizable unsaturated monomers with adamantyl groups: Adamantyl (meth)acrylate and the like.

(iv) Polymerizable unsaturated monomers with tricyclodecenyl groups: Tricyclodecenyl (meth)acrylate and the like.

(v) Aromatic ring-containing polymerizable unsaturated monomers: Monomers such as benzyl (meth)acrylate, styrene, α-methyl styrene and vinyltoluene.

(vi) Polymerizable unsaturated monomers with alkoxysilyl groups: Vinyltrimethoxysilane, vinyltriethoxysilane, vinyltris(2-methoxyethoxy)silane, γ-(meth)acryloyloxypropyltrimethoxysilane, γ-(meth)acryloyloxypropyltriethoxysilane and the like.

(vii) Polymerizable unsaturated monomers with fluorinated alkyl groups: Perfluoroalkyl (meth)acrylates such as perfluorobutylethyl (meth)acrylate and perfluorooctylethyl (meth)acrylate, and fluoroolefins and the like.

(viii) Polymerizable unsaturated monomers with photopolymerizable functional groups such as maleimide.

(ix) Vinyl compounds: N-Vinylpyrrolidone, ethylene, butadiene, chloroprene, vinyl propionate, vinyl acetate and the like.

(x) Carboxyl group-containing polymerizable unsaturated monomers: Monomers such as (meth)acrylic acid, maleic acid, crotonic acid and β-carboxyethyl (meth)acrylate.

(xi) Nitrogen-containing polymerizable unsaturated monomers: (Meth)acrylonitrile, (meth)acrylamide, N,N-dimethylaminoethyl (meth)acrylate, N,N-diethylaminoethyl (meth)acrylate, N,N-dimethylaminopropyl (meth)acrylamide, methylenebis(meth)acrylamide, ethylenebis(meth)acrylamide, and glycidyl (meth)acrylate and amine compound addition products and the like.

(xii) Polymerizable unsaturated monomers with two or more polymerizable unsaturated groups in the molecule: Monomers such as allyl (meth)acrylate, ethylene glycol di(meth)acrylate, 1,4-butanediol di(meth)acrylate, neopentyl glycol di(meth)acrylate and 1,6-hexanediol di(meth)acrylate.

(xiii) Epoxy group-containing polymerizable unsaturated monomers: Monomers such as glycidyl (meth)acrylate, β-methylglycidyl (meth)acrylate, 3,4-epoxycyclohexylmethyl (meth)acrylate, 3,4-epoxycyclohexylethyl (meth)acrylate, 3,4-epoxycyclohexylpropyl (meth)acrylate and allyl glycidyl ether.

(xiv) (Meth)acrylates having polyoxyethylene chains with alkoxy groups at the molecular ends.

(xv) Polymerizable unsaturated monomers with sulfonic acid groups: 2-Acrylamide methylpropanesulfonic acid, 2-sulfoethyl (meth)acrylate, allylsulfonic acid, 4-styrenesulfonic acid and the like; and sodium salts and ammonium salts of these sulfonic acids, and the like.

(xvi) Polymerizable unsaturated monomers with phosphate groups: Acid phosphooxyethyl (meth)acrylate, acid phosphooxypropyl (meth)acrylate, acid phosphooxypoly(oxyethylene)glycol (meth)acrylate, acid phosphooxypoly(oxypropylene)glycol (meth)acrylate, and the like.

(xvii) Polymerizable unsaturated monomers with ultraviolet absorbing functional groups: Monomers such as 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone and 2-[2-hydroxy-5-[2-(methacryloyloxy)ethyl]phenyl]-2H-benzotriazole.

(xviii) Light-stable polymerizable unsaturated monomers: Monomers such as 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyl oxy-2,2,6,6-tetramethylpiperidine, 4-crotonoylamino-2,2,6,6-tetramethylpiperidine and 1-crotonoyl-4-crotonoyloxy-2,2,6,6-tetramethylpiperidine.

(xix) Polymerizable unsaturated monomers with carbonyl groups: Monomers such as acrolein, diacetoneacrylamide, diacetonemethacrylamide, acetoacetoxyethyl methacrylate, formylstyrol and vinylalkyl ketones with 4 to 7 carbon atoms (for example, vinylmethyl ketone, vinylethyl ketone and vinylbutyl ketone).

(xx) Polymerizable unsaturated monomers with acid anhydride groups: Monomers such as maleic anhydride, itaconic anhydride and citraconic anhydride.

As used herein, “polymerizable unsaturated group” means an unsaturated group that can participate in radical polymerization. Examples of such polymerizable unsaturated groups include vinyl group and (meth)acryloyl group.

Also, as used herein, “(meth)acrylate” refers to acrylate or methacrylate. The term “(meth)acrylic acid” refers to acrylic acid or methacrylic acid. The term “(meth)acryloyl” refers to acryloyl or methacryloyl. The term “(meth)acrylamide” refers to acrylamide or methacrylamide.

The use proportion of the hydroxyl group-containing polymerizable unsaturated monomer when producing the hydroxyl group-containing acrylic resin (B1) is preferably 1 to 50 mass %, more preferably 2 to 40 mass % and even more preferably 3 to 30 mass %, based on the total amount of the monomer components.

From the viewpoint of the curability, chipping resistance, adhesiveness and finished appearance of the obtained coating film, the hydroxyl group-containing acrylic resin (B1) has a hydroxyl value of preferably 1 to 200 mgKOH/g, more preferably 2 to 180 mgKOH/g and even more preferably 5 to 150 mgKOH/g.

Also, from the viewpoint of the storage stability of the present coating material and the water resistance of the obtained coating film, the hydroxyl group-containing acrylic resin (B1) has an acid value of preferably 1 to 150 mgKOH/g, more preferably 5 to 100 mgKOH/g and even more preferably 5 to 80 mgKOH/g.

When the aqueous coating composition of the invention contains the hydroxyl group-containing acrylic resin (B1), the content of the hydroxyl group-containing acrylic resin (B1) is preferably in the range of 1 to 30 parts by mass, more preferably in the range of 2 to 20 parts by mass and even more preferably in the range of 3 to 15 parts by mass, based on 100 parts by mass as the resin solid content of the aqueous coating composition.

### Hydroxyl Group-Containing Polyester Resin (B2)

The hydroxyl group-containing polyester resin (B2) used may be a water-soluble or water-dispersible polyester resin which is conventionally known for use in aqueous coating materials.

The hydroxyl group-containing polyester resin (B2) can generally be produced by esterification reaction or transesterification reaction between an acid component and an alcohol component.

The acid component used may be a compound that is commonly used as an acid component for production of polyester resins. Examples of such acid components include aliphatic polybasic acids, alicyclic polybasic acids and aromatic polybasic acids.

The aliphatic polybasic acid will generally be an aliphatic compound having two or more carboxyl groups in the molecule, an acid anhydride of such an aliphatic compound, or an ester of such an aliphatic compound. Examples for aliphatic polybasic acids include aliphatic polybasic carboxylic acids such as succinic acid, glutaric acid, adipic acid, pimelic acid, suberic acid, azelaic acid, sebacic acid, undecanedioic acid, dodecanedioic acid, brassylic acid, octadecanedioic acid, citric acid and butanetetracarboxylic acid; anhydrides of such aliphatic polybasic carboxylic acids; and esterified products of such aliphatic polybasic carboxylic acids with lower alkyl groups of about 1 to 4 carbon atoms. The aliphatic polybasic acid used may be one type or a combination of two or more types.

The aliphatic polybasic acid used is preferably adipic acid and/or adipic anhydride, from the viewpoint of smoothness of the coating film that is to be obtained.

The alicyclic polybasic acid will generally be a compound having one or more alicyclic structures and two or more carboxyl groups in the molecule, or an acid anhydride of such a compound or an esterified form of such a compound. An alicyclic structure is generally a 4- to 6-membered cyclic structure. Examples of alicyclic polybasic acids include alicyclic polybasic carboxylic acids such as 1,2-cyclohexanedicarboxylic acid, 1,3-cyclohexanedicarboxylic acid, 1,4-cyclohexanedicarboxylic acid, 4-cyclohexene-1,2-dicarboxylic acid, 3-methyl-1,2-cyclohexanedicarboxylic acid, 4-methyl-1,2-cyclohexanedicarboxylic acid, 1,2,4-cyclohexanetricarboxylic acid and 1,3,5-cyclohexanetricarboxylic acid; anhydrides of these alicyclic polybasic carboxylic acids; and esterified products of these alicyclic polybasic carboxylic acids with lower alkyl groups of about 1 to 4 carbon atoms. The alicyclic polybasic acid used may be one type or a combination of two or more types.

From the viewpoint of smoothness of the coating film that is to be obtained, the alicyclic polybasic acid used is preferably 1,2-cyclohexanedicarboxylic acid, 1,2-cyclohexanedicarboxylic anhydride, 1,3-cyclohexanedicarboxylic acid, 1,4-cyclohexanedicarboxylic acid, 4-cyclohexene-1,2-dicarboxylic acid or 4-cyclohexene-1,2-dicarboxylic anhydride, among which 1,2-cyclohexanedicarboxylic acid and/or 1,2-cyclohexanedicarboxylic anhydride are more preferably used.

An aromatic polybasic acid is generally an aromatic compound having two or more carboxyl groups in the molecule, an acid anhydride of such an aromatic compound or an esterified form of such an aromatic compound, and examples include aromatic polybasic carboxylic acids such as phthalic acid, isophthalic acid, terephthalic acid, naphthalenedicarboxylic acid, 4,4′-biphenyldicarboxylic acid, trimellitic acid and pyromellitic acid; anhydrides of such aromatic polybasic carboxylic acids; and esterified products of such aromatic polybasic carboxylic acids with lower alkyl groups of about 1 to 4 carbon atoms. The aromatic polybasic acid used may be one type or a combination of two or more types.

The aromatic polybasic acid used is preferably phthalic acid, phthalic anhydride, isophthalic acid, trimellitic acid or trimellitic anhydride.

Acid components other than the aforementioned aliphatic polybasic acids, alicyclic polybasic acids and aromatic polybasic acids may also be used. Such acid components are not particularly restricted, and examples include fatty acids such as coconut fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid and safflower oil fatty acid; monocarboxylic acids such as lauric acid, myristic acid, palmitic acid, stearic acid, oleic acid, linoleic acid, linolenic acid, benzoic acid, p-tert-butylbenzoic acid, cyclohexanoic acid and 10-phenyloctadecanoic acid; and hydroxycarboxylic acids such as lactic acid, 3-hydroxybutanoic acid and 3-hydroxy-4-ethoxybenzoic acid. These acid components may be used either alone or in combinations of two or more.

As the alcohol component there may be suitably used a polyhydric alcohol having two or more hydroxyl groups in the molecule. Examples of polyhydric alcohols include dihydric alcohols such as ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 2-methyl-1,3-propanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, neopentyl glycol, 1,4-cyclohexanedimethanol, tricyclodecanedimethanol, neopentyl glycol hydroxypivalate ester, hydrogenated bisphenol A, hydrogenated bisphenol F and dimethylolpropionic acid; polylactone diols with lactone compounds such as 8-caprolactone added to these dihydric alcohols; ester diol compounds such as bis(hydroxyethyl) terephthalate; polyether diol compounds such as bisphenol A alkylene oxide addition products, polyethylene glycol, polypropylene glycol and polybutylene glycol; trihydric and greater alcohols such as glycerin, trimethylolethane, trimethylolpropane, diglycerin, triglycerin, 1,2,6-hexanetriol, pentaerythritol, dipentaerythritol, tris(2-hydroxyethyl)isocyanuric acid, sorbitol and mannitol; polylactone polyol compounds with lactone compounds such as 8-caprolactone added to these trihydric and greater alcohols; and fatty acid esterified glycerin.

Alcohol components other than the aforementioned polyhydric alcohols may also be used. Such alcohol components are not particularly restricted, and examples include monoalcohols such as methanol, ethanol, propyl alcohol, butyl alcohol, stearyl alcohol and 2-phenoxyethanol; and alcohol compounds obtained by reacting acids with monoepoxy compounds such as propylene oxide, butylene oxide, “CARDURA E10P” (trade name of Hexion, glycidyl ester of synthetic highly-branched saturated fatty acid), and the like.

The method for producing the hydroxyl group-containing polyester resin is not particularly restricted, and it may be a common method. For example, a hydroxyl group-containing polyester resin can be produced by a method of heating the acid component and the alcohol component under a nitrogen stream at about 150 to 250° C. for about 5 to 10 hours, for esterification reaction or transesterification reaction between the acid component and alcohol component.

When the acid component and alcohol component are subjected to esterification reaction or transesterification reaction, they may be added all at once to the reactor, or one or both may be added in separate portions. Alternatively, after the hydroxyl group-containing polyester resin has first been synthesized, an acid anhydride may be reacted with the obtained hydroxyl group-containing polyester resin for half-esterification, to obtain a carboxyl group- and hydroxyl group-containing polyester resin. Also alternatively, after a carboxyl group-containing polyester resin has first been synthesized, the alcohol component may be added to obtain a hydroxyl group-containing polyester resin.

During the esterification or transesterification reaction, a known catalyst such as dibutyltin oxide, antimony trioxide, zinc acetate, manganese acetate, cobalt acetate, calcium acetate, lead acetate, tetrabutyl titanate or tetraisopropyl titanate may be used as a catalyst for acceleration of the reaction.

The hydroxyl group-containing polyester resin may also be modified with a fatty acid, monoepoxy compound, polyisocyanate compound or acrylic resin either during or after preparation of the resin.

Examples as fatty acids that may be suitably used include coconut fatty acid, cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid and safflower oil fatty acid, and a preferred example for the monoepoxy compound is “CARDURA E10P” (trade name of Hexion, glycidyl ester of synthetic highly-branched saturated fatty acid).

Examples for the polyisocyanate compound include organic polyisocyanates, such as aliphatic diisocyanate compounds such as lysine diisocyanate, hexamethylene diisocyanate and trimethylhexane diisocyanate; alicyclic diisocyanate compounds such as hydrogenated xylylene diisocyanate, isophorone diisocyanate, methylcyclohexane-2,4-diisocyanate, methylcyclohexane-2,6-diisocyanate, 4,4′-methylenebis(cyclohexylisocyanate) and 1,3-(isocyanatomethyl)cyclohexane; aromatic diisocyanate compounds such as tolylene diisocyanate, xylylene diisocyanate and diphenylmethane diisocyanate; and trivalent and greater polyisocyanates such as lysine triisocyanate; as well as addition products of these organic polyisocyanates with polyhydric alcohols, low molecular weight polyester resins, water or the like; cyclized polymers formed between these organic polyisocyanates (for example, isocyanurates) and biuret-type addition products. These polyisocyanate compounds may be used alone or in mixtures of two or more.

The method used to modify the hydroxyl group-containing polyester resin with an acrylic resin may be a known method, and for example, it may be a method of polymerizing a mixture of a polymerizable unsaturated group-containing polyester resin and a polymerizable unsaturated monomer, or a method of reacting a hydroxyl group-containing polyester resin with an acrylic resin.

The hydroxyl group-containing polyester resin (B2) has a hydroxyl value of preferably 1 to 250 mgKOH/g, more preferably 2 to 200 mgKOH/g and even more preferably 5 to 200 mgKOH/g.

When the hydroxyl group-containing polyester resin (B2) also has a carboxyl group, the acid value is preferably 1 to 150 mgKOH/g, more preferably 2 to 100 mgKOH/g and even more preferably 2 to 80 mgKOH/g.

The weight-average molecular weight of the hydroxyl group-containing polyester resin (B2) is preferably 3,000 to 100,000, more preferably 4,000 to 50,000 and even more preferably 5,000 to 30,000.

As used herein, the average molecular weight is the value calculated from a chromatogram measured by gel permeation chromatography based on the molecular weight of standard polystyrene. An HLC8120GPC apparatus (product of Tosoh Corp.) was used for the gel permeation chromatography. Four columns were used, namely “TSKgel G-4000HXL”, “TSKgel G-3000HXL”, “TSKgel G-2500HXL” and “TSKgel G-2000HXL” (all trade names of Tosoh Corp.), with the following conditions: mobile phase: tetrahydrofuran, measuring temperature: 40° C., flow rate: 1 mL/min, detector: RI.

When the aqueous coating composition of the invention contains the hydroxyl group-containing polyester resin (B2), the content of the hydroxyl group-containing polyester resin (B2) is preferably in the range of 1 to 30 parts by mass, more preferably in the range of 2 to 20 parts by mass and even more preferably in the range of 3 to 15 parts by mass, based on 100 parts by mass as the resin solid content of the aqueous coating composition.

### Organic Solvent (C)

The organic solvent (C) is an organic solvent with a solubility parameter in the range of 8.8 to 10.1.

If the solubility parameter of the organic solvent (C) is 8.8 or greater it will be possible to form a coating film with an excellent finished appearance at dust sections, and if the solubility parameter is 10.1 or lower it will be possible to form a coating film with an excellent finished appearance at the film-formed sections. From the viewpoint of the finished appearance at both the dust sections and film-formed sections of the coating film that is formed, the solubility parameter of the organic solvent (C) is preferably 8.9 to 9.7 and more preferably 9.1 to 9.7.

The solubility parameter [units: (cal/cm³)^{1/2}] of an organic solvent is the value calculated from the basic construction of a compound by the method proposed by Fedors. Specifically, the solubility parameter is calculated from the vaporization energy Ae (cal) of each atom or atomic group at 25° C., and the molar volume Av (cm³) of each atom or atomic group at the same temperature, using the following formula.

Solubility parameter=(ΣΔe/ΣΔv)^{1/2}

(Reference: Mukai, J., Kinjo, N., “Gijutsusha no Tame no Jitsugaku Koubunshi” (Practical Polymer science for Engineers), Kodansha, October, 1981, p. 71-′7′7).

Examples for the organic solvent (C) include cyclohexanol acetate (solubility parameter: 9.2), propylene glycol diacetate (solubility parameter: 9.6), 1,4-butanediol diacetate (solubility parameter: 9.6), 1,3-butylene glycol diacetate (solubility parameter: 9.5), 1,6-hexanediol diacetate (solubility parameter: 9.5), methyl acetate (solubility parameter: 8.8), ethyleneglycol monomethyl ether acetate (solubility parameter: 9.0), ethyleneglycol monobutyl ether acetate (solubility parameter: 8.9), diethyleneglycol monoethyl ether acetate (solubility parameter: 9.0), diethyleneglycol monobutyl ether acetate (solubility parameter: 8.9), ethyleneglycol monobutyl ether (solubility parameter: 8.9), propyleneglycol n-propyl ether (solubility parameter: 9.8), propyleneglycol n-butyl ether (solubility parameter: 9.7), dipropyleneglycol methyl ether (solubility parameter: 9.7), dipropyleneglycol n-propyl ether (solubility parameter: 9.5), dipropyleneglycol n-butyl ether (solubility parameter: 9.4), tripropyleneglycol methyl ether (solubility parameter: 9.4) and tripropyleneglycol n-butyl ether (solubility parameter: 9.3).

From the viewpoint of storage stability of the present coating material and the finished appearance at both the dust sections and film-formed sections of the coating film that is formed, the organic solvent (C) has a boiling point preferably in the range of 130 to 230° C. and more preferably in the range of 150 to 200° C.

Examples for an organic solvent (C) with a boiling point in the range of 130 to 230° C. include cyclohexanol acetate (boiling point: 173° C.), propyleneglycol diacetate (boiling point: 190° C.), ethyleneglycol monomethyl ether acetate (boiling point: 145° C.), ethyleneglycol monobutyl ether acetate (boiling point: 188° C.), diethyleneglycol monoethyl ether acetate (boiling point: 217° C.), ethyleneglycol monobutyl ether (boiling point: 171° C.), propyleneglycol n-propyl ether (boiling point: 150° C.), propyleneglycol n-butyl ether (boiling point: 170° C.), dipropyleneglycol methyl ether (boiling point: 190° C.), dipropyleneglycol n-propyl ether (boiling point: 212° C.) and dipropyleneglycol n-butyl ether (boiling point: 229° C.).

The organic solvent (C) used may be a single type or a combination of two or more types.

The content of the organic solvent (C) in the aqueous coating composition of the invention is in the range of 5 to 30 parts by mass, based on 100 parts by mass as the resin solid content of the aqueous coating composition.

If the content of the organic solvent (C) is 5 parts by mass or greater based on 100 parts by mass as the resin solid content of the aqueous coating composition it will be possible to form a coating film with excellent finished appearance even at dust sections, and if it is 30 parts by mass or lower it will be possible to form a coating film with excellent finished appearance even at film-formed sections. From the viewpoint of forming a coating film with excellent finished appearance at both the dust sections and film-formed sections, the content of the organic solvent (C) is more preferably in the range of 6 to 25 parts by mass and even more preferably in the range of 7 to 20 parts by mass, based on 100 parts by mass as the resin solid content in the aqueous coating composition.

### Aqueous Coating Composition

The aqueous coating composition of the invention is an aqueous coating composition including: (A) a urethane resin obtained from constituent components including a polyisocyanate component (a1) and a polyol component (a2) comprising a polyether polyol (a2-1) and a polycarbonate polyol (a2-2), (B) one or more hydroxyl group-containing resins selected from among hydroxyl group-containing acrylic resins (B1) and hydroxyl group-containing polyester resins (B2), (C) an organic solvent with a solubility parameter in the range of 8.8 to 10.1 and (D) water, wherein the content of the urethane resin (A) is in the range of 60 to 85 parts by mass and the content of the organic solvent (C) is in the range of 5 to 30 parts by mass, based on 100 parts by mass as the resin solid content of the aqueous coating composition.

The aqueous coating composition of the invention preferably further comprises a curing agent (E) from the viewpoint of finished appearance, water resistance and adhesiveness of the coating film that is to be formed.

### Curing Agent (E)

The curing agent (E) is a compound that can react with the hydroxyl groups in the hydroxyl group-containing resin (B) to cure the aqueous coating composition of the invention. The curing agent (E) used may be a single type alone or a combination of two or more types.

Examples for the curing agent (E) include melamine resins (E1), polyisocyanate compounds (E2) and blocked polyisocyanate compounds (E3).

Melamine resins (E1) and blocked polyisocyanate compounds (E3) are preferred, and melamine resins (E1) are more preferred, from the viewpoint of finished appearance, water resistance, chipping resistance and adhesiveness of the coating film to be formed.

A melamine resin (E1) used may be a partially methylolated melamine resin or completely methylolated melamine resin obtained by reacting a melamine component and an aldehyde component. Aldehyde components include formaldehyde, paraformaldehyde, acetaldehyde and benzaldehyde.

Also, the methylol groups in the methylolated melamine resin may be partially or completely etherified with a suitable alcohol. Examples of alcohols to be used for the etherification include methyl alcohol, ethyl alcohol, n-propyl alcohol, isopropyl alcohol, n-butyl alcohol, isobutyl alcohol, 2-ethyl-1-butanol and 2-ethyl-1-hexanol.

Preferred melamine resins (E1) are methyl etherified melamine resins having a methylol group of a partially or completely methylolated melamine resin partially or completely etherified with methyl alcohol, butyl etherified melamine resins having a methylol group of a partially or completely methylolated melamine resin partially or completely etherified with butyl alcohol, and methyl-butyl mixed etherified melamine resins having methylol groups of a partially or completely methylolated melamine resin partially or completely etherified with methyl alcohol and butyl alcohol.

The melamine resin (E1) has a weight-average molecular weight of preferably 400 to 6,000, more preferably 500 to 4,000 and even more preferably 600 to 3,000.

The melamine resin (E1) that is used may be a commercial product. Examples of trade names of commercial products include “CYMEL 202”, “CYMEL 203”, “CYMEL 204”, “CYMEL 211”, “CYMEL 212”, “CYMEL 238”, “CYMEL 251”, “CYMEL 253”, “CYMEL 254”, “CYMEL 303”, “CYMEL 323”, “CYMEL 324”, “CYMEL 325”, “CYMEL 327”, “CYMEL 350”, “CYMEL 370”, “CYMEL 380”, “CYMEL 385”, “CYMEL 1156”, “CYMEL 1158”, “CYMEL 1116” and “CYMEL 1130” (all by Allnex, Japan); “RESIMINE 735”, “RESIMINE 740”, “RESIMINE 741”, “RESIMINE 745”, “RESIMINE 746” and “RESIMINE 747” (all by Monsanto Corp.); “U-VAN 120”, “U-VAN 20HS”, “U-VAN 20SE”, “U-VAN 2021”, “U-VAN 2028” and “U-VAN 28-60” (all by Mitsui Chemicals, Inc.); and “SUMIMAL M55”, “SUMIMAL M30W” and “SUMIMAL M50W” (all by Sumitomo Chemical Co., Ltd.).

When the aqueous coating composition of the invention comprises the melamine resin (E1), the content of the melamine resin (E1) is preferably in the range of 1 to 30 parts by mass, more preferably in the range of 2 to 20 parts by mass and even more preferably in the range of 3 to 15 parts by mass, based on 100 parts by mass as the resin solid content of the aqueous coating composition.

The polyisocyanate compound (E2) used may be any of the compounds mentioned for explanation of the polyisocyanate component (a1).

Also, the polyisocyanate compound (E2) that is used may be a prepolymer obtained by reacting any of the aforementioned polyisocyanates and their derivatives with a compound that can react with the polyisocyanate, under conditions with an excess of isocyanate groups. Compounds that can react with the aforementioned polyisocyanates include compounds with active hydrogen groups such as hydroxyl and amino, and specifically there may be used polyhydric alcohols, low molecular weight polyester resins, amines, water and the like.

The polyisocyanate compound used may also be a polymer of an isocyanate group-containing polymerizable unsaturated monomer, or a copolymer of such an isocyanate group-containing polymerizable unsaturated monomer and a polymerizable unsaturated monomer other than the isocyanate group-containing polymerizable unsaturated monomer.

The blocked polyisocyanate compound (E3) is a compound wherein the isocyanate groups of the polyisocyanate compound (E2) are blocked with a blocking agent.

Examples of such blocking agents include phenol-based compounds such as phenol, cresol, xylenol, nitrophenol, ethylphenol, hydroxydiphenyl, butylphenol, isopropylphenol, nonylphenol, octylphenol and methyl hydroxybenzoate; lactam-based compounds such as 8-caprolactam, 6-valerolactam, γ-butyrolactam and β-propiolactam; aliphatic alcohol-based compounds such as methanol, ethanol, propyl alcohol, butyl alcohol, amyl alcohol and lauryl alcohol; ether-based compounds such as ethyleneglycol monomethyl ether, ethyleneglycol monoethyl ether, ethyleneglycol monobutyl ether, diethyleneglycol monomethyl ether, diethyleneglycol monoethyl ether, propyleneglycol monomethyl ether and methoxymethanol; alcohol-based compounds such as benzyl alcohol, glycolic acid, methyl glycolate, ethyl glycolate, butyl glycolate, lactic acid, methyl lactate, ethyl lactate, butyl lactate, methylolurea, methylolmelamine, diacetone alcohol, 2-hydroxyethyl acrylate and 2-hydroxyethyl methacrylate; oxime-based compounds such as formamideoxime, acetamideoxime, acetooxime, methylethylketooxime, diacetylmonooxime, benzophenoneoxime and cyclohexaneoxime; active methylene-based compounds such as dimethyl malonate, diethyl malonate, ethyl acetoacetate, methyl acetoacetate and acetylacetone; mercaptane-based compounds such as butylmercaptane, t-butylmercaptane, hexylmercaptane, t-dodecylmercaptane, 2-mercaptobenzothiazole, thiophenol, methylthiophenol and ethylthiophenol; acid amide-based compounds such as acetoanilide, acetanisidide, acetotoluide, acrylamide, methacrylamide, acetic acid amide, stearic acid amide and benzamide; imide-based compounds such as succinic acid imide, phthalic acid imide and maleic acid imide; amine-based compounds such as diphenylamine, phenylnaphthylamine, xylidine, N-phenylxylidine, carbazole, aniline, naphthylamine, butylamine, dibutylamine and butylphenylamine; imidazole-based compounds such as imidazole and 2-ethylimidazole; urea-based compounds such as urea, thiourea, ethyleneurea, ethylenethiourea and diphenylurea; carbamic acid ester-based compounds such as phenyl N-phenylcarbamate; imine-based compounds such as ethyleneimine and propyleneimine; sulfite-based compounds such as sodium bisulfite and potassium bisulfite; and azole-based compounds. Azole-based compounds include pyrazole or pyrazole derivatives, such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole and 3-methyl-5-phenylpyrazole; imidazole or imidazole derivatives, such as imidazole, benzimidazole, 2-methylimidazole, 2-ethylimidazole and 2-phenylimidazole; and imidazoline derivatives such as 2-methylimidazoline and 2-phenylimidazoline.

Preferred blocking agents among these include active methylene-based blocking agents, and pyrazole or pyrazole derivatives.

A solvent may also be added as necessary for blocking (reaction with a blocking agent). The solvent used for the blocking reaction may be any one that is not reactive with isocyanate groups, examples of which include ketone-based solvents such as acetone and methyl ethyl ketone, ester-based solvents such as ethyl acetate, and solvents such as N-methyl-2-pyrrolidone (NMP).

Blocking agents that may be used include hydroxycarboxylic acids having one or more hydroxyl groups and one or more carboxyl groups, such as hydroxypivalic acid or dimethylolpropionic acid. It is particularly preferred to use a blocked polyisocyanate compound which has the isocyanate group blocked using the hydroxycarboxylic acid, and subsequently has the carboxyl group of the hydroxycarboxylic acid neutralized, to provide water-dispersibility.

When the aqueous coating composition of the invention comprises a blocked polyisocyanate compound (E3), the content of the blocked polyisocyanate compound (E3) is preferably in the range of 1 to 30 parts by mass, more preferably in the range of 2 to 20 parts by mass and even more preferably in the range of 3 to 15 parts by mass, based on 100 parts by mass as the resin solid content of the aqueous coating composition.

### Other Components

If necessary, the aqueous coating composition of the invention may also comprise a resin other than the urethane resin (A), hydroxyl group-containing acrylic resin (B1) and hydroxyl group-containing polyester resin (B2), or a pigment, an organic solvent other than the organic solvent (C), or a curing catalyst, dispersing agent, anti-settling agent, antifoaming agent, thickening agent, ultraviolet absorber, light stabilizer or surface control agent.

Examples of resin components other than the urethane resin (A), hydroxyl group-containing acrylic resin (B1) and hydroxyl group-containing polyester resin (B2) include acrylic resins that do not contain hydroxyl groups, polyester resins that do not contain hydroxyl groups, polyether resins optionally containing hydroxyl groups, polycarbonate resins optionally containing hydroxyl groups, and epoxy resins optionally containing hydroxyl groups.

The pigment used may be a color pigment, extender pigment or brightness pigment, for example. Such pigments may be used alone or in combinations of two or more.

When the aqueous coating composition of the invention comprises such a pigment, the content of the pigment is preferably in the range of 1 to 200 parts by mass, preferably 5 to 160 parts by mass and more preferably 15 to 140 parts by mass, based on 100 parts by mass as the resin solid content in the aqueous coating composition.

Examples for the color pigment include titanium oxide, zinc oxide, carbon black, molybdenum red, Prussian blue, cobalt blue, azo-based pigments, phthalocyanine-based pigments, quinacridone-based pigments, isoindoline-based pigments, threne-based pigments, perylene-based pigments, dioxazine-based pigments, diketopyrrolopyrrole-based pigments and the like.

When the aqueous coating composition of the invention comprises a color pigment, the content of the color pigment is in the range of 1 to 180 parts by mass, preferably 5 to 150 parts by mass and more preferably 15 to 130 parts by mass, based on 100 parts by mass as the resin solid content in the aqueous coating composition.

Examples of extender pigments include barium sulfate, talc, clay, kaolin, barium carbonate, calcium carbonate, silica and alumina white.

When the aqueous coating composition of the invention comprises an extender pigment, the content of the extender pigment is in the range of 1 to 180 parts by mass, preferably 5 to 140 parts by mass and more preferably 10 to 120 parts by mass, based on 100 parts by mass as the resin solid content in the aqueous coating composition.

Examples of brightness pigments include aluminum (including vapor deposited aluminum), copper, zinc, brass, nickel, glass flakes, aluminum oxide, mica, titanium oxide- and/or iron oxide-coated aluminum oxide, and titanium oxide- and/or iron oxide-coated mica.

When the aqueous coating composition of the invention comprises a brightness pigment, the content of the brightness pigment is in the range of 0.1 to 100 parts by mass, preferably 1 to 50 parts by mass and more preferably 3 to 25 parts by mass, based on 100 parts by mass as the resin solid content in the aqueous coating composition.

Organic solvents other than the organic solvent (C) include ester-based solvents such as butyl acetate; alcohol-based solvents such as isopropyl alcohol, n-butanol and isobutanol; aromatic hydrocarbon-based solvents and aliphatic hydrocarbon-based solvents.

Specific compounds of curing catalysts include organometallic compounds such as tin octylate, dibutyltin diacetate, dibutyltin di(2-ethyl hexanoate), dibutyltin dilaurate, dioctyltin diacetate, dioctyltin di(2-ethyl hexanoate), dibutyltin oxide, dibutyltin sulfide, dioctyltin oxide, dibutyltin fatty acid salts, lead 2-ethylhexanoate, zinc octylate, zinc naphthenate, fatty acid zinc compounds, bismuth octanoate, bismuth 2-ethylhexanoate, bismuth oleate, bismuth neodecanoate, bismuth versatate, bismuth naphthenate, cobalt naphthenate, calcium octylate, copper naphthenate and tetra(2-ethylhexyl) titanate; sulfonic acid group-containing compounds such as paratoluenesulfonic acid, dodecylbenzenesulfonic acid, dinonylnaphthalenesulfonic acid and sulfonic acid group-containing resins; and phosphoric acid group-containing compounds such as monobutylphosphoric acid, dibutylphosphoric acid, mono-2-ethylhexylphosphoric acid, di-2-ethylhexylphosphoric acid, alkyl etherphosphoric acid, polyoxyethylenealkyl etherphosphoric acid and phosphoric acid group-containing resins.

For use, the aqueous coating composition of the invention may be applied after adding water and/or an organic solvent for dilution to adjust it to the appropriate viscosity, as necessary.

The appropriate viscosity will differ depending on the coating composition, but it is preferably adjusted as appropriate using water and/or an organic solvent to a viscosity in the range of 300 to 3000 mPa·s as measured using a Brookfield viscometer at 20° C. with a rotational speed of 6 rpm, for example.

The coating solid concentration of the aqueous coating composition will usually be about 5 to 70 mass % and is preferably about 10 to 55 mass %.

The aqueous coating composition of the invention may be either a one-pack type coating material or a multi-pack type coating material, but it is preferably a one-pack type coating material from the viewpoint of excellent productivity without a coating material mixing step, and of allowing maintenance of the coating machine to be simplified.

The aqueous coating composition of the invention may be coated onto an article to be coated by a known method such as air spray coating, airless spray coating, rotary atomizing coating or curtain coating, for example, and electrostatic application may also be carried out during the coating. Methods of air spray coating and rotary atomizing coating are preferred among these. Such coating methods may be carried out once or several times, until the desired film thickness is obtained.

The coating amount of the aqueous coating composition of the invention is preferably an amount for a cured film thickness of 1 to 20 μm, more preferably 2 to 15 μm and even more preferably 3 to 13 μm.

The article to be coated with the aqueous coating composition of the invention is not particularly restricted.

The aqueous coating composition of the invention enable coating films having an excellent outer appearance to be formed not only on the film-formed sections but also on dust sections.

### Method for Forming Multilayer Coating Film

Since the aqueous coating material coating composition of the invention makes it possible to obtain multilayer coating films with excellent finished appearance of dust sections and film-formed sections, as well as chipping resistance, it is suitable for use as a chipping primer paint for an automobile, for example.

An automobile chipping primer paint is generally a coating material applied to an outer plate of an automobile body.

The following methods (M1) and (M2) may be mentioned as preferred modes of the method for forming a multilayer coating film of the invention.

### Method (M1)

A method for forming a multilayer coating film, which includes:
step (M1-1): a step of applying an aqueous coating composition of the invention onto an article to be coated to form a chipping primer coating film,
step (M1-2): a step of applying an aqueous intermediate coating composition onto the chipping primer coating film formed in step (M1-1) to form an intermediate coating film,
step (M1-3): a step of applying a base coating composition onto the intermediate coating film formed in step (M1-2) to form a base coating film,
step (M1-4): a step of applying a clear coating composition onto the base coating film formed in step (M1-3) to form a clear coating film, and
step (M1-5): a step of heat curing the chipping primer coating film, intermediate coating film, base coating film and clear coating film formed in steps (M1-1) to (M1-4) all at once.

### Method (M2)

A method for forming a multilayer coating film, which includes:
step (M2-1): a step of applying an aqueous coating composition of the invention onto an article to be coated to form a chipping primer coating film,
step (M2-2): a step of applying an aqueous intermediate coating composition onto the chipping primer coating film formed in step (M2-1) to form an intermediate coating film,
step (M2-3): a step of heat curing the chipping primer coating film and intermediate coating film formed in steps (M2-1) and (M2-2) all at once,
step (M2-4): a step of applying a base coating composition onto the intermediate coating film cured in step (M2-3) to form a base coating film,
step (M2-5): a step of applying a clear coating composition onto the base coating film formed in step (M2-4) to form a clear coating film, and
step (M2-6): a step of heat curing the base coating film and clear coating film formed in steps (M2-4) and (M2-5) all at once.

The chipping primer coating film may be a formed film, or it may be in a dust-like form.

After applying the aqueous coating composition of the invention, it may be preheated under heating conditions that essentially do not cure the chipping primer coating film, and then air blown. Alternatively, it may be allowed to stand at room temperature without heating for an interval of about 1 to 60 minutes. It is preferably allowed to stand at room temperature without heating for an interval of about 1 to 60 minutes.

The temperature for preheating is preferably 40 to 100° C., more preferably 50 to 90° C. and even more preferably 60 to 80° C. The preheating time is preferably 30 seconds to 15 minutes, more preferably 1 to 10 minutes and even more preferably 2 to 5 minutes.

Air blowing is preferably carried out by usually blasting the coated surface of the coated article with air of a temperature of ordinary temperature or heated to about 25° C. to 80° C., for a period of about 30 seconds to 15 minutes.

Examples for the article to be coated include outer plates of automobile bodies of passenger vehicles, trucks, motorcycles and buses; and automobile parts. Outer plates of automobile bodies are preferred, and especially preferred are hood and roof sections of automobile bodies, which require excellent finished appearance and chipping resistance.

The material of the article to be coated is also not particularly restricted. Examples include metal materials such as iron, aluminum, brass, copper, tin plate, stainless steel, galvanized steel and alloyed zinc (such as Zn—Al, Zn—Ni and Zn—Fe)-plated steel; resins such as polyethylene resins, polypropylene resins, acrylonitrile-butadiene-styrene (ABS) resins, polyamide resins, acrylic resins, vinylidene chloride resins, polycarbonate resins, polyurethane resins and epoxy resins or plastic materials such as various types of FRPs. Metal materials are preferred among these.

Surfaces of articles to be coated, onto which the coating film may be applied, include metal surfaces including metal base materials such as automobile body outer plates, automobile parts, and the steel sheets composing them, and they may be subjected to surface treatment such as phosphate treatment, chromate treatment or complex oxide treatment.

Articles, and optionally surface-treated articles, may also have additional coating films formed on them. For example, articles to be coated used as base materials, which are surface treated as necessary, may also have undercoat coating films formed on them. When the article to be coated is an automobile body, for example, an undercoat coating film may be formed using a known primer coating composition that is commonly used for coating of automobile bodies.

The primer coating composition will usually be applied for the purpose of imparting corrosion resistance to the article.

A primer coating composition used for formation of an undercoat coating film may be an electrodeposition coating, for example, and preferably a cationic electrodeposition coating.

The undercoat coating film is also preferably a cured coating film from the viewpoint of finished appearance of the multilayer coating film that is to be formed.

The aqueous intermediate coating composition used may be any thermosetting aqueous intermediate coating composition that is known for coating onto automobile bodies and the like. Examples for the aqueous intermediate coating composition that are suitable for use include thermosetting coating materials comprising base resins with crosslinkable functional groups, crosslinking agents, color pigments and extender pigments.

The aqueous intermediate coating composition is usually applied for the purpose of imparting smoothness and chipping resistance to the article to be coated, and adhesiveness between coating films.

Examples of crosslinkable functional groups in the base resin include carboxyl, hydroxyl and epoxy groups.

Examples of types of base resins include acrylic resins, polyester resins, alkyd resins and urethane resins.

The crosslinking agent used may be, for example, a melamine resin, polyisocyanate compound or a blocked polyisocyanate compound.

The coating amount of the aqueous intermediate coating composition is preferably an amount for a cured film thickness of 10 to 60 μm, more preferably 15 to 50 μm and even more preferably 20 to 40 μm.

The base coating composition to be used may be any thermosetting base coating composition that is known for coating of automobile bodies and the like. Examples for the base coating composition that are suitable for use include thermosetting coating compositions comprising base resins with crosslinkable functional groups, crosslinking agents, color pigments and extender pigments.

The base coating composition will usually be applied for the purpose of imparting an excellent design property (for example, color, metallic feel or gloss) to the article to be coated.

Examples of crosslinkable functional groups in the base resin include carboxyl, hydroxyl and epoxy groups.

Examples of types of base resins include acrylic resins, polyester resins, alkyd resins and urethane resins.

The crosslinking agent used may be, for example, a melamine resin, polyisocyanate compound or a blocked polyisocyanate compound.

The base coating composition may be any aqueous coating composition or organic solvent-based coating material composition, but it is preferably an aqueous coating composition from the viewpoint of reducing environmental load.

The coating amount of the base coating composition is preferably an amount for a cured film thickness of 5 to 40 μm, more preferably 6 to 35 μm and even more preferably 7 to 30 μm.

The clear coating composition may be any thermosetting clear coating composition that is known for coating onto automobile bodies and the like. The thermosetting clear coating composition may be, for example, an organic solvent-type thermosetting coating composition, an aqueous thermosetting coating composition or a powder thermosetting coating composition, containing a base resin with a crosslinkable functional group, and a curing agent.

The clear coating composition will usually be applied for the purpose of imparting an outer appearance (such as gloss) and durability (such as weather resistance and water resistance) to the article to be coated.

Examples of crosslinkable functional groups in the base resin include carboxyl, hydroxyl, epoxy and silanol groups. Examples of types of resins for the base resin include acrylic resins, polyester resins, alkyd resins, urethane resins, epoxy resins and fluorine resins. Examples for the curing agent include polyisocyanate compounds, blocked polyisocyanate compounds, melamine resins, urea resins, carboxyl group-containing compounds, carboxyl group-containing resins, epoxy group-containing resins and epoxy group-containing compounds.

Preferred base resin/curing agent combinations for the clear coating composition include hydroxyl group-containing resin/polyisocyanate compounds, carboxyl group-containing resin/epoxy group-containing resins, hydroxyl group-containing resin/blocked polyisocyanate compounds and hydroxyl group-containing resin/melamine resin combinations, with hydroxyl group-containing resin/polyisocyanate compound combinations being more preferred.

The clear coating composition may also be a one-pack type coating material, or a multi-pack type coating material such as a two-pack type urethane resin coating material.

The clear coating composition may also contain, as necessary, color pigments, brightness pigments and/or dyes in ranges that do not impair the transparency, and may further contain, as suitable, extender pigments, ultraviolet absorbers, light stabilizers, antifoaming agents, thickening agents, rust inhibitors, surface control agents and the like.

The method of applying the clear coating composition is not particularly restricted, and for example, a wet coating film may be formed by a method such as air spray coating, airless spray coating, rotary atomizing coating or curtain coating. An electrostatic charge may also be applied if necessary in these coating methods. Air spray coating and rotary atomizing coating are especially preferred. The coating amount of the clear coating composition is usually preferred to be an amount that produces a cured film thickness of preferably 10 to 70 μm and more preferably 20 to 50 μm.

When carrying out air spray coating, airless spray coating or rotary atomizing coating, the viscosity of the clear coating composition is preferably adjusted as appropriate using an organic solvent or other solvent to within a suitable viscosity range for coating, which will usually be a viscosity range of about 15 to 60 seconds and especially 20 to 50 seconds at 20° C., as measured with a No. 4 Ford cup viscometer.

Heating may be carried out by publicly known heating means, using a drying furnace such as an air heating furnace, electric furnace or infrared induction heating furnace, for example. The heating temperature is preferably 60 to 180° C., more preferably 70 to 170° C. and even more preferably 80 to 160° C. The heating time is not particularly restricted but is in the range of preferably 10 to 40 minutes and more preferably 20 to 40 minutes.

### EXAMPLES

The present invention will now be explained in greater detail using Production Examples, Examples and Comparative Examples. The Production Examples, Examples and Comparative Examples are merely for illustration and are not intended to limit the scope of the invention. Throughout the Production Examples, Examples and Comparative Examples, the “parts” and “%” values are based on mass, unless otherwise specified. The film thicknesses of the coating films are based on the cured coating films.

### Production of Urethane Resin (A)

### Production Example 1

After charging 233.4 parts of “PTMG2000” (trade name of Mitsubishi Chemical Corp., polytetramethylene ether glycol with a number-average molecular weight of 1000), 120.7 parts of “ETERNACOLL UH-200” (trade name of Ube Industries, Ltd., polycarbonate diol with a number-average molecular weight of 1000), 0.9 part of cyclohexanedimethanol, 16.6 parts of dimethylolpropionic acid and 290 parts of methyl ethyl ketone into a reactor equipped with a thermometer, thermostat, stirrer, reflux condenser and water separator, the mixture was increased in temperature to 70° C. while stirring, after which a mixture of 80.6 parts of isophorone diisocyanate and 1.6 parts of hydrogenated MDI was added dropwise over 30 minutes and stirring was continued while maintaining a temperature of 70° C., to obtain an NCO-terminal prepolymer with a free isocyanate group content of 8.0%. The obtained reaction product was cooled to 30° C. and 6.6 parts of dimethylethanolamine was added, after which 761.5 parts of deionized water was added, the mixture was emulsified, 74.1 parts of a 5% aqueous diethylenetriamine solution was added and the mixture was stirred for 120 minutes for chain extension reaction. The methyl ethyl ketone was distilled off while heating under reduced pressure, and the concentration was adjusted with deionized water to obtain a urethane resin emulsion (A-1) with a solid content of 35%, an acid value of 15 mgKOH/g and a mean particle size of 120 nm. The polyether polyol/polycarbonate polyol mass ratio of the urethane resin emulsion (A-1) was 66/34.

### Production Examples 2 to 8

Urethane emulsion dispersions (A-2) to (A-8) were obtained in the same manner as Production Example 1, except that the composition in Production Example 1 was changed as listed in Table 1 below.

TABLE 1

| Production Example | | | 1 | 2 | 3 | 4 | 5 | 6 | 7 | 8 |
|---|---|---|---|---|---|---|---|---|---|---|
| Urethane resin emulsion | | | A-1 | A-2 | A-3 | A-4 | A-5 | A-6 | A-7 | A-8 |
| Polyisocyanate | Isophorone diisocyanate | | 80.6 | 72.9 | 68.5 | 1.3 | 75.5 | 68.9 | 79.7 | 67.5 |
| component (a1) | Hydrogenated MDI | | 1.6 | 1.6 | 1.6 | 84.1 | 1.6 | 1.6 | 1.6 | 1.6 |
| Polyol | Polyether polyol | PTMG2000 | 233.4 | | | | | | | |
| component (a2) | | PTMG3000 (*1) | | 241.0 | 241.0 | 232.4 | 144.6 | 363.3 | | |
| | Polycarbonate | ETERNACOLL UH-200 | 120.7 | 120.7 | | 114.2 | 213.5 | | 352.3 | |
| | polyol | ETERNACOLL UH-300 (*2) | | | 121.6 | | | | | |
| | Other polyol | Kuraray Polyol P-3010 (*3) | | | | | | | | 363.6 |
| | | Cyclohexanedimethanol | 0.9 | 0.9 | 0.9 | 0.9 | 0.9 | 0.9 | 0.9 | 0.9 |
| | | Dimethylolpropionic acid | 16.6 | 16.6 | 16.5 | 16.5 | 16.6 | 16.6 | 16.6 | 16.6 |

| Polyether polyol/polycarbonate polyol mass ratio | | 66/34 | 67/33 | 67/33 | 67/33 | 40/60 | 100/0 | 0/100 | 0/0 |
|---|---|---|---|---|---|---|---|---|---|
| Dimethylethanolamine | | 6.6 | 6.6 | 6.6 | 6.6 | 6.6 | 6.6 | 6.6 | 6.6 |
| Diethylenetriamine | | 3.7 | 3.7 | 3.7 | 3.7 | 3.7 | 3.7 | 3.7 | 3.7 |
| Characteristic | Solid content (%) | 35 | 35 | 35 | 35 | 35 | 35 | 35 | 35 |
| value | Acid value (mgKOH/g) | 15 | 15 | 15 | 15 | 15 | 15 | 15 | 15 |
| | Mean particle size (nm) | 120 | 129 | 144 | 131 | 119 | 175 | 110 | 138 |

(*1) “PTMG3000”: trade name of Mitsubishi Chemical Corp., polytetramethylene ether glycol with number-average molecular weight: 3000,
(*2) “ETERNACOLL UH-300”: trade name of Ube Industries, Ltd., polycarbonate diol with number-average molecular weight: 3000,
(*3) “KURARAY POLYOL P-3010”: trade name of Kuraray Co., Ltd., polyester polyol with number-average molecular weight: 3000.

### Production of Hydroxyl Group-Containing Acrylic Resin (B1)

### Production Example 9

After charging 30 parts of butyl acetate (solubility parameter: 8.7) into a reactor equipped with a thermometer, thermostat, stirrer, reflux condenser, nitrogen inlet tube and dropper, and heating to 85° C., a mixture of 10 parts of styrene, 30 parts of methyl methacrylate, 15 parts of 2-ethylhexyl acrylate, 11.5 parts of n-butyl acrylate, 30 parts of hydroxyethyl acrylate, 3.5 parts of acrylic acid, 10 parts of butyl acetate (solubility parameter: 8.7) and 2 parts of 2,2′-azobis(2,4-dimethylvaleronitrile) was added dropwise over a period of 4 hours, and upon completion of the dropwise addition the mixture was aged for 1 hour. Next, a mixture of 5 parts of butyl acetate (solubility parameter: 8.7) and 1 part of 2,2′-azobis(2,4-dimethylvaleronitrile) was further added dropwise into the flask over a period of 1 hour, and upon completion of the dropwise addition the mixture was aged for 1 hour. There was further added 3.03 parts of 2-(dimethylamino)ethanol, and deionized water was slowly added to obtain a hydroxyl group-containing acrylic resin solution (B1-1) with a solid concentration of 40%. The acid value of the obtain hydroxyl group-containing acrylic resin solution (B1-1) was 27 mgKOH/g, the hydroxyl value was 145 mgKOH/g, and the number-average molecular weight was 5000.

### Production of Hydroxyl Group-Containing Polyester Resin (B2)

### Production Example 10

Into a four-necked flask equipped with a heating apparatus, stirrer, thermometer, reflux condenser and water separator there were charged 61.9 parts of 1,3-cyclohexanedicarboxylic acid, 70.1 parts of adipic acid, 62.8 parts of trimethylolpropane, 24.2 parts of neopentyl glycol and 44.6 parts of 1,4-cyclohexanedimethanol, and the contents were heated from 160° C. to 230° C. over a period of 3 hours, after which it was held at 230° C. for 1 hour and the produced condensation water was distilled off using a rectification column.

After then adding 15.0 parts of trimellitic anhydride to the product, the solvent was removed and the product was neutralized with 2-(dimethylamino)ethanol, and then dispersed in water to obtain a hydroxyl group-containing polyester resin solution (B2-1) with a solid content of 40%. The hydroxyl value of the obtained hydroxyl group-containing polyester resin solution (B2-1) was 150 mgKOH/g, the acid value was 35 mgKOH/g and the number-average molecular weight was 2,000.

### Production of Blocked Polyisocyanate Compound (E3)

### Production Example 11

After charging 1550 parts of “SUMIDUR N-3300” (trade name of Sumika Bayer Urethane Co., Ltd., polyisocyanate containing isocyanurate structure derived from hexamethylene diisocyanate, solid content: approximately 100%, isocyanate group content: 21.8%) and 0.9 part of 2,6-di-t-butyl-4-methylphenol into a reactor equipped with a thermometer, thermostat, stirrer, reflux condenser, nitrogen inlet tube and dropper, the contents were thoroughly mixed and heated under a nitrogen stream at 130° C. for 3 hours. Next, 1200 parts of ethyl acetate (solubility parameter: 8.7) and 1350 parts of diisopropyl malonate were charged in, and then 14 parts of a 28% solution of sodium methoxide in methanol (solubility parameter: 13.8) was added while stirring under a nitrogen stream, and the mixture was stirred at 65° C. for 8 hours and diluted with ethyl acetate (solubility parameter: 8.7) to a final solid content of 70%, to obtain a blocked polyisocyanate compound (E3-1) having a solid content of 70% and a weight-average molecular weight of 4,200.

### Production of Pigment Dispersions

### Production Example 12

After mixing 12.5 parts of the hydroxyl group-containing acrylic resin solution (B1-1) obtained in Production Example 9 (solid content: 5 parts), 50 parts of “JR-806” (trade name of Tayca Corp., rutile titanium dioxide), 1 part of “Carbon MA-100” (trade name of Mitsubishi Chemical Corp., carbon black) and 10 parts of deionized water, the pH was adjusted to 8.4 with 2-(dimethylamino)ethanol. Next, the obtained liquid mixture was placed in a wide-mouth glass bottle, glass beads of approximately 1.3 mmφ diameter were added as a dispersion medium, the bottle was sealed, and the mixture was dispersed for 30 minutes with a paint shaker to obtain a pigment dispersion (P-1).

### Production Example 13

After mixing 12.5 parts of the hydroxyl group-containing polyester resin solution (B2-1) obtained in Production Example 10 (5 parts solid content: 5 parts), 50 parts of “JR-806” (trade name of Tayca Corp., rutile titanium dioxide), 1 part of “Carbon MA-100” (trade name of Mitsubishi Chemical Corp., carbon black) and 10 parts of deionized water, the pH was adjusted to 8.4 with 2-(dimethylamino)ethanol. Next, the obtained liquid mixture was placed in a wide-mouth glass bottle, glass beads of approximately 1.3 mmφ diameter were added as a dispersion medium, the bottle was sealed, and the mixture was dispersed for 30 minutes with a paint shaker to obtain a pigment dispersion (P-2).

### Production of Aqueous Coating Compositions

### Example 1

There were uniformly mixed 73.5 parts of the pigment dispersion (P-2) obtained in Production Example 13, 228.6 parts of the urethane resin emulsion (A-1) obtained in Production Example 1 (solid content: 80 parts), 12.5 parts of the hydroxyl group-containing acrylic resin solution (B1-1) obtained in Production Example 9 (solid content: 5 parts), 10 parts of “CYMEL 350” (trade name of Allnex, Japan, methyletherified melamine resin, solid content: 100%) (solid content: 10 parts) and 10 parts of propylene glycol n-butyl ether (solubility parameter: 9.7, boiling point: 170° C.). To the obtained mixture there were then added deionized water, “ADEKA NOL UH-530” (trade name of Adeka Corp., thickening agent, solid content: 30%) and 2-(dimethylamino)ethanol, to obtain aqueous coating composition No. 1 having pH 8.4, a coating material solid content of 30%, and a viscosity of 1000 mPa·s as measured using a Brookfield viscometer at 20° C. with a rotational speed of 6 rpm.

### Examples 2 to 19 and Comparative Examples 1 to 10

Aqueous coating compositions No. 2 to 29 having pH 8.4, coating material solid contents of 30%, and viscosities of 1000 mPa·s as measured using a Brookfield viscometer at 20° C. with a rotational speed of 6 rpm, were obtained in the same manner as Example 1 except for using the compositions listed in Table 2. The compositions in Table 2 are shown as contents for organic solvents, while the other components are listed as solid mass.

The storage stabilities of aqueous coating compositions No. 1 to 29 were evaluated by the rate of change between the viscosity immediately after production and the viscosity after standing for 10 days at 40° C., based on the viscosity after 1 minute at 60 rpm measured using an “LVDV-I” (Brookfield type viscometer, trade name of Brookfield Co.). The mixtures were stirred for 5 minutes at 1000 rpm with a Disper mixer before viscosity measurement.

Viscosity change rate (%)=|(Viscosity after standing for 10 days at 40° C.)/viscosity immediately after production)−1|×100

Scores of VG and G are acceptable.
VG: viscosity change rate of <20%,
G: viscosity change rate of ≥20% and <50%,
P: viscosity change rate of ≥50%.

The storage stability results are shown in Table 2.

TABLE 2

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Aqueous coating composition No. | | | 1 | 2 | 3 | 4 | 5 | 6 | 7 | 8 | 9 | 10 |
| Pigment dispersion | Pigment dispersion name | | P-2 | P-1 | P-2 | P-2 | P-2 | P-2 | P-2 | P-2 | P-2 | P-2 |
| | Hydroxyl group- | Hydroxyl group-containing | | 5 | | | | | | | | |
| | containing resin (B) | acrylic resin solution (B1-1) | | | | | | | | | | |
| | | Hydroxyl group-containing | 5 | | 5 | 5 | 5 | 5 | 5 | 5 | 5 | 5 |
| | | polyester resin solution (B2-1) | | | | | | | | | | |
| | Pigment | JR-806 | 50 | 50 | 50 | 50 | 50 | 50 | 50 | 50 | 50 | 50 |
| | | Carbon MA-100 | 1 | 1 | 1 | 1 | 1 | 1 | 1 | 1 | 1 | 1 |
| Urethane resin(A) | Urethane resin (A-1) | | 80 | | | | | | | | | |
| | Urethane resin (A-2) | | | 80 | 80 | 80 | 80 | 80 | 80 | 80 | 80 | 80 |
| | Urethane resin (A-3) | | | | | | | | | | | |
| | Urethane resin (A-4) | | | | | | | | | | | |
| | Urethane resin (A-5) | | | | | | | | | | | |
| | Urethane resin (A-6) | | | | | | | | | | | |
| | Urethane resin (A-7) | | | | | | | | | | | |
| | Urethane resin (A-8) | | | | | | | | | | | |
| Hydroxyl group- | Hydroxyl group-containing acrylic | | 5 | 5 | | 5 | 10 | 5 | 5 | 5 | 5 | 5 |
| containing resin (B) | resin solution (B1-1) | | | | | | | | | | | |
| | Hydroxyl group-containing polyester | | | | 5 | | 5 | | | | | |
| | resin solution (B2-1) | | | | | | | | | | | |
| Curing agent (E) | Melamine resin (E1) | CYMEL 350 | 10 | 10 | 10 | 10 | | | 10 | 10 | 10 | 10 |
| | Blocked polyisocyanate | Blocked polyisocyanate | | | | | | 10 | | | | |
| | compound (E3) | compound (E3-1) | | | | | | | | | | |

| | | | | | | | | | | | |
|---|---|---|---|---|---|---|---|---|---|---|---|
| Organic solvent (C) | Propyleneglycol n-butyl ether | 10 | 10 | 10 | 10 | 10 | 10 | 5 | 18 | 25 | |
| | Propyleneglycol n-propyl ether (*4) | | | | | | | | | | 10 |
| | Tripropyleneglycol n-butyl ether (*5) | | | | | | | | | | |
| | Ethylene glycol monobutylether acetate (*6) | | | | | | | | | | |
| Organic solvent | Propyleneglycol monomethyl ether acetate (*7) | | | | | | | | | | |
| other than organic | Propyleneglycol monomethyl ether (*8) | | | | | | | | | | |
| solvent (C) | | | | | | | | | | | |

| | | | | | | | | | | |
|---|---|---|---|---|---|---|---|---|---|---|
| Storage stability | VG | VG | G | VG | VG | VG | G | VG | VG | VG |

| | | | Example | | | | | | | | |
|---|---|---|---|---|---|---|---|---|---|---|---|
| | | | 11 | 12 | 13 | 14 | 15 | 16 | 17 | 18 | 19 |
| Aqueous coating composition No. | | | 11 | 12 | 13 | 14 | 15 | 16 | 17 | 18 | 19 |
| Pigment dispersion | Pigment dispersion name | | P-2 | P-2 | P-2 | P-2 | P-2 | P-2 | P-2 | P-2 | P-2 |
| | Hydroxyl group- | Hydroxyl group-containing | | | | | | | | | |
| | containing resin (B) | acrylic resin solution (B1-1) | | | | | | | | | |
| | | Hydroxyl group-containing | 5 | 5 | 5 | 5 | 5 | 5 | 5 | 5 | 5 |
| | | polyester resin solution (B2-1) | | | | | | | | | |
| | Pigment | JR-806 | 50 | 50 | 50 | 50 | 50 | 50 | 50 | 50 | 50 |
| | | Carbon MA-100 | 1 | 1 | 1 | 1 | 1 | 1 | 1 | 1 | 1 |
| Urethane resin(A) | Urethane resin (A-1) | | | | | | | | | | |
| | Urethane resin (A-2) | | 80 | 80 | 80 | 80 | 80 | 65 | | | |
| | Urethane resin (A-3) | | | | | | | | 80 | | |
| | Urethane resin (A-4) | | | | | | | | | 80 | |
| | Urethane resin (A-5) | | | | | | | | | | 80 |
| | Urethane resin (A-6) | | | | | | | | | | |
| | Urethane resin (A-7) | | | | | | | | | | |
| | Urethane resin (A-8) | | | | | | | | | | |
| Hydroxyl group- | Hydroxyl group-containing acrylic | | 5 | 5 | 5 | 5 | 5 | 10 | 5 | 5 | 5 |
| containing resin (B) | resin solution (B1-1) | | | | | | | | | | |
| | Hydroxyl group-containing polyester | | | | | | | 10 | | | |
| | resin solution (B2-1) | | | | | | | | | | |
| Curing agent (E) | Melamine resin (E1) | CYMEL 350 | 10 | 10 | 10 | 10 | 10 | 10 | 10 | 10 | 10 |
| | Blocked polyisocyanate | Blocked polyisocyanate | | | | | | | | | |
| | compound (E3) | compound (E3-1) | | | | | | | | | |

| | | | | | | | | | | |
|---|---|---|---|---|---|---|---|---|---|---|
| Organic solvent (C) | Propyleneglycol n-butyl ether | | | 7 | 7 | 7 | 10 | 10 | 10 | 10 |
| | Propyleneglycol n-propyl ether (*4) | | | | | | | | | |
| | Tripropyleneglycol n-butyl ether (*5) | 10 | | 3 | | | | | | |
| | Ethyleneglycol monobutyl ether acetate (*6) | | 10 | | | | | | | |
| Organic solvent | Propyleneglycol monomethyl ether acetate (*7) | | | | 3 | | | | | |
| other than organic | Propyleneglycol monomethyl ether (*8) | | | | | 3 | | | | |
| solvent (C) | | | | | | | | | | |

| | | | | | | | | | |
|---|---|---|---|---|---|---|---|---|---|
| Storage stability | VG | VG | VG | VG | VG | VG | VG | VG | VG |

| | | | Comparative Example | | | | | | | | | |
|---|---|---|---|---|---|---|---|---|---|---|---|---|
| | | | 1 | 2 | 3 | 4 | 5 | 6 | 7 | 8 | 9 | 10 |
| Aqueous coating composition No. | | | 20 | 21 | 22 | 23 | 24 | 25 | 26 | 27 | 28 | 29 |
| Pigment dispersion | Pigment dispersion name | | P-2 | P-2 | P-2 | P-2 | P-2 | P-2 | P-2 | P-2 | P-2 | P-2 |
| | Hydroxyl group- | Hydroxyl group-containing | | | | | | | | | | |
| | containing resin (B) | acrylic resin solution (B1-1) | | | | | | | | | | |
| | | Hydroxyl group-containing | 5 | 5 | 5 | 5 | 5 | 5 | 5 | 5 | 5 | 5 |
| | | polyester resin solution (B2-1) | | | | | | | | | | |
| | Pigment | JR-806 | 50 | 50 | 50 | 50 | 50 | 50 | 50 | 50 | 50 | 50 |
| | | Carbon MA-100 | 1 | 1 | 1 | 1 | 1 | 1 | 1 | 1 | 1 | 1 |
| Urethane resin(A) | Urethane resin (A-1) | | | | | | | | | | | |
| | Urethane resin (A-2) | | | | | 55 | 90 | 80 | 80 | 80 | 80 | 80 |
| | Urethane resin (A-3) | | | | | | | | | | | |
| | Urethane resin (A-4) | | | | | | | | | | | |
| | Urethane resin (A-5) | | | | | | | | | | | |
| | Urethane resin (A-6) | | 80 | | | | | | | | | |
| | Urethane resin (A-7) | | | 80 | | | | | | | | |
| | Urethane resin (A-8) | | | | 80 | | | | | | | |
| Hydroxyl group- | Hydroxyl group-containing acrylic | | 5 | 5 | 5 | 15 | 5 | 5 | 5 | 5 | 5 | 5 |
| containing resin (B) | resin solution (B1-1) | | | | | | | | | | | |
| | Hydroxyl group-containing polyester | | | | | 15 | | | | | | |
| | resin solution (B2-1) | | | | | | | | | | | |
| Curing agent (E) | Melamine resin (E1) | CYMEL 350 | 10 | 10 | 10 | 15 | | 10 | 10 | 10 | 10 | 10 |
| | Blocked polyisocyanate | Blocked polyisocyanate | | | | | | | | | | |
| | compound (E3) | compound (E3-1) | | | | | | | | | | |

| | | | | | | | | | | | |
|---|---|---|---|---|---|---|---|---|---|---|---|
| Organic solvent (C) | Propyleneglycol n-butyl ether | 10 | 10 | 10 | 10 | 10 | 2 | 35 | | | |
| | Propyleneglycol n-propyl ether (*4) | | | | | | | | | | |
| | Tripropyleneglycol n-butyl ether (*5) | | | | | | | | | | |
| | Ethyleneglycol monobutyl ether acetate (*6) | | | | | | | | | | |
| Organic solvent | Propyleneglycol monomethyl ether acetate (*7) | | | | | | | | 10 | 5 | |
| other than organic | Propyleneglycol monomethyl ether (*8) | | | | | | | | | 5 | 10 |
| solvent (C) | | | | | | | | | | | |

| | | | | | | | | | | |
|---|---|---|---|---|---|---|---|---|---|---|
| Storage stability | P | VG | VG | P | G | G | VG | VG | VG | VG |

(*4) Propylene glycol n-propyl ether: solubility parameter = 9.8, boiling point = 150° C.,
(*5) Tripropylene glycol n-butyl ether: solubility parameter = 9.3, boiling point = 274° C.,
(*6) Ethyleneglycol monobutyl ether acetate: solubility parameter = 8.9, boiling point = 188° C.,
(*7) Propyleneglycol monomethyl ether acetate: solubility parameter = 8.7, boiling point = 146° C.,
(*8) Propyleneglycol monomethyl ether: solubility parameter = 10.2, boiling point = 121° C.

### (Fabrication of Article to be Coated for Testing)

A zinc phosphate-treated cold-rolled steel sheet was electrodeposited with a thermosetting epoxy resin-based cationic electrodeposition coating composition (trade name “ELECRON GT-10” by Kansai Paint Co., Ltd.) to a film thickness of 20 μm, and heated at 170° C. for 30 minutes for curing. A test sheet comprising an electrodeposition coating formed on the steel sheet was thus fabricated.

### (Fabrication of Test Sheets)

### Example 20

Aqueous coating composition No. 1 obtained in Example 1 was applied by graded coating using a hand gun to produce a gradient in the film thickness (0 to 10 μm, film-formed section standard film thickness: 8 μm), in order to obtain dust sections and film-formed sections on each obtained test sheet, and the coatings were allowed to stand for 5 minutes to form uncured chipping primer coating films.

A rotary atomizing electrostatic coater was then used for electrostatic coating of “WP-523H” (trade name of Kansai Paint Co., Ltd., acryl-melamine resin-based aqueous intermediate coating composition) onto the uncured chipping primer coating film to a cured film thickness of 30 μm, and it was allowed to stand for 5 minutes to form an uncured intermediate coating film.

A rotary atomizing electrostatic coater was then used for electrostatic coating of “WBC-720H” (trade name of Kansai Paint Co., Ltd., acryl-melamine resin-based aqueous base coating composition) onto the uncured intermediate coating film to a dry film thickness of 15 μm, and it was allowed to stand for 5 minutes and then preheated at 80° C. for 3 minutes to form an uncured base coating film.

Next, “LUGA-BAKE HK-4” (trade name of Kansai Paint Co., Ltd., melamine curable clear coating material, base resin/curing agent combination: hydroxyl group-containing resin/melamine resin) was electrostatically coated onto the uncured base coating film to a dry film thickness of 35 μm and allowed to stand for 7 minutes to form a clear coating film.

It was then heated at 140° C. for 30 minutes, thereby heat curing the chipping primer coating film, intermediate coating film, base coating film and clear coating film to fabricate a test sheet.

### Examples 21 to 38 and Comparative Examples 11 to 20

Test sheets were fabricated in the same manner as Example 20, except that the type of aqueous coating composition used in Example 20 was changed as shown in Table 3.

### Example 39

Aqueous coating composition No. 2 obtained in Example 2 was applied by graded coating using a hand gun to produce a gradient in the film thickness (0 to 10 μm, film-formed section standard film thickness: 8 μm), in order to obtain dust sections and film-formed sections on each obtained test sheet, and the coating was allowed to stand for 5 minutes to form an uncured chipping primer coating film.

A rotary atomizing electrostatic coater was then used for electrostatic coating of “WP-523H” (trade name of Kansai Paint Co., Ltd., acryl-melamine resin-based aqueous intermediate coating composition) onto the uncured chipping primer coating film to a cured film thickness of 30 μm, and it was allowed to stand for 5 minutes to form an uncured intermediate coating film.

It was then heated at 140° C. for 30 minutes for heat curing of the chipping primer coating film and intermediate coating film.

A rotary atomizing electrostatic coater was then used for electrostatic coating of “WBC-720H” (trade name of Kansai Paint Co., Ltd., acryl-melamine resin-based aqueous base coating composition) onto the heat cured intermediate coating film to a dry film thickness of 15 μm, and it was allowed to stand for 5 minutes and then preheated at 80° C. for 3 minutes to form an uncured base coating film.

Next, “LUGA-BAKE HK-4” (trade name of Kansai Paint Co., Ltd., melamine curable clear coating material, base resin/curing agent combination: hydroxyl group-containing resin/melamine resin) was electrostatically coated onto the uncured base coating film to a dry film thickness of 35 μm and allowed to stand for 7 minutes to form a clear coating film.

It was then heated at 140° C. for 30 minutes, thereby heat curing the base coating film and clear coating film to fabricate a test sheet.

Each of the obtained test sheets was evaluated by the following test methods. The evaluation results are shown in Table 3.

### (Test Methods)

Finished appearance of dust sections of chipping primer coating film: Each test sheet was evaluated for sharpness based on the Short Wave (SW) value and Wa value measured using a “Wave Scan” (trade name of BYK Gardner). Smaller values for the SW and Wa values indicate higher sharpness of the coating surface. A score of 30 is acceptable.

Finished appearance of film-formed sections of chipping primer coating film: Each test sheet was evaluated for sharpness based on the Short Wave (SW) value and Wa value measured using a “Wave Scan” (trade name of BYK Gardner). Smaller values for the SW and Wa values indicate higher sharpness of the coating surface. A score of ≤30 is acceptable.

Chipping resistance: Each test sheet of the film-formed section of the chipping primer coating film was set on the sample holding stage of a Model JA-400 graval test instrument (trade name of Suga Test Instruments Co., Ltd., chipping resistance tester), and 50 g of road-grade crushed stone (S-5) according to JIS A 5001 was impacted onto the test sheet at an angle of 90°, using compressed air at 0.39 MPa (4 kgf/cm²), at −20° C. at a distance of 35 cm from the test sheet. The obtained test sheet was then washed with water and dried, and cloth adhesive tape (product of Nichiban Co., Ltd.) was attached to the coating surface and peeled off, after which the extent of damage in the coating film was visually examined and evaluated on the following scale. Scores of VG and G are acceptable.
VG: Very small damage size, no exposure of electrodeposition surface or base steel sheet.
G: Small damage size, no exposure of electrodeposition surface or base steel sheet.
F: Small damage size, but some exposure of electrodeposition surface or base steel sheet.
P: Considerable damage size, with exposure of base steel sheet.

TABLE 3

| | | | Evaluation results | | | | |
|---|---|---|---|---|---|---|---|
| | | | Finished appearance | | | | |
| | | | Dust sections of | | Film-formed sections of | | Chipping |
| | | | chipping primer coat film | | chipping primer coat film | | resistance |
| | | Aqueous coating | Sharpness | Sharpness | Sharpness | Sharpness | Film-formed |
| | | composition No. | (SW value) | (Wa value) | (SW value) | (Wa value) | section |
| Example | 20 | 1 | 18 | 20 | 19 | 22 | VG |
| | 21 | 2 | 20 | 21 | 20 | 21 | VG |
| | 22 | 3 | 20 | 20 | 21 | 22 | VG |
| | 23 | 4 | 21 | 20 | 21 | 21 | VG |
| | 24 | 5 | 24 | 21 | 22 | 23 | VG |
| | 25 | 6 | 25 | 23 | 23 | 20 | G |
| | 26 | 7 | 28 | 23 | 24 | 21 | VG |
| | 27 | 8 | 23 | 22 | 23 | 26 | VG |
| | 28 | 9 | 22 | 23 | 25 | 29 | VG |
| | 29 | 10 | 21 | 23 | 23 | 22 | VG |
| | 30 | 11 | 23 | 24 | 23 | 23 | VG |
| | 31 | 12 | 24 | 24 | 21 | 22 | VG |
| | 32 | 13 | 21 | 23 | 22 | 23 | VG |
| | 33 | 14 | 26 | 24 | 22 | 22 | VG |
| | 34 | 15 | 27 | 23 | 21 | 25 | VG |
| | 35 | 16 | 19 | 20 | 21 | 28 | VG |
| | 36 | 17 | 24 | 23 | 22 | 19 | VG |
| | 37 | 18 | 22 | 21 | 22 | 24 | G |
| | 38 | 19 | 25 | 22 | 23 | 25 | G |
| | 39 | 2 | 18 | 19 | 18 | 19 | G |
| Comp. | 11 | 20 | 37 | 25 | 20 | 19 | VG |
| Example | 12 | 21 | 20 | 22 | 25 | 30 | F |
| | 13 | 22 | 19 | 20 | 26 | 40 | P |
| | 14 | 23 | 19 | 20 | 23 | 33 | G |
| | 15 | 24 | 31 | 23 | 22 | 23 | VG |
| | 16 | 25 | 33 | 25 | 22 | 21 | VG |
| | 17 | 26 | 23 | 27 | 28 | 32 | VG |
| | 18 | 27 | 35 | 30 | 22 | 23 | VG |
| | 19 | 28 | 23 | 24 | 28 | 34 | VG |
| | 20 | 29 | 21 | 23 | 29 | 36 | VG |

Embodiments and Examples of the invention were described above, but the invention is not limited to these embodiments and may incorporate various modifications based on the technical concept of the invention. The constructions, methods, steps, forms, materials and numerical values mentioned for the embodiments and Examples serve merely for illustration, and different constructions, methods, steps, forms, materials and numerical values may be used as necessary. The constructions, methods, steps, forms, materials and numerical values of the embodiments described above may also be combined together, so long as the gist of the invention is maintained.

1. An aqueous coating composition that includes:
(A) a urethane resin obtained from constituent components including (a1) a polyisocyanate component and (a2) a polyol component comprising (a2-1) a polyether polyol and (a2-2) a polycarbonate polyol,
(B) one or more hydroxyl group-containing resins selected from among (B1) hydroxyl group-containing acrylic resins and (B2) hydroxyl group-containing polyester resins,
(C) an organic solvent with a solubility parameter in the range of 8.8 to 10.1 and
(D) water,
wherein:
the content of the urethane resin (A) is in the range of 60 to 85 parts by mass and the content of the organic solvent (C) is in the range of 5 to 30 parts by mass, based on 100 parts by mass as the resin solid content of the aqueous coating composition.

2. The aqueous coating composition according to claim 1, wherein the ratio of the polyether polyol (a2-1) and the polycarbonate polyol (a2-2) in the polyol component (a2) is 80/20 to 30/70, as the mass ratio of polyether polyol (a2-1)/polycarbonate polyol (a2-2).

3. The aqueous coating composition according to claim 1, wherein the solubility parameter of the organic solvent (C) is in the range of 8.9 to 9.7.

4. The aqueous coating composition according to claim 1, further comprising a curing agent (E).

5. The aqueous coating composition according to claim 4, wherein the curing agent (E) is at least one selected from among melamine resins (E1) and blocked polyisocyanate compounds (E3).

6. A method for forming a multilayer coating film, which includes:
step (M1-1): a step of applying an aqueous coating composition according to claim 1 onto an article to be coated to form a chipping primer coating film,
step (M1-2): a step of applying an aqueous intermediate coating composition onto the chipping primer coating film formed in step (M1-1) to form an intermediate coating film,
step (M1-3): a step of applying a base coating composition onto the intermediate coating film formed in step (M1-2) to form a base coating film,
step (M1-4): a step of applying a clear coating composition onto the base coating film formed in step (M1-3) to form a clear coating film, and
step (M1-5): a step of heat curing the chipping primer coating film, intermediate coating film, base coating film and clear coating film formed in steps (M1-1) to (M1-4) all at once.

7. A method for forming a multilayer coating film, which includes:
step (M2-1): a step of applying an aqueous coating composition according to claim 1 onto an article to be coated to form a chipping primer coating film,
step (M2-2): a step of applying an aqueous intermediate coating composition onto the chipping primer coating film formed in step (M2-1) to form an intermediate coating film,
step (M2-3): a step of heat curing the chipping primer coating film and intermediate coating film formed in steps (M2-1) and (M2-2) all at once,
step (M2-4): a step of applying a base coating composition onto the intermediate coating film cured in step (M2-3) to form a base coating film,
step (M2-5): a step of applying a clear coating composition onto the base coating film formed in step (M2-4) to form a clear coating film, and
step (M2-6): a step of heat curing the base coating film and clear coating film formed in steps (M2-4) and (M2-5) all at once.

8. The aqueous coating composition according to claim 2, wherein the solubility parameter of the organic solvent (C) is in the range of 8.9 to 9.7.

9. The aqueous coating composition according to claim 2, further comprising a curing agent (E).

10. The aqueous coating composition according to claim 3, further comprising a curing agent (E).

11. The aqueous coating composition according to claim 8, further comprising a curing agent (E).

12. The aqueous coating composition according to claim 9, wherein the curing agent (E) is at least one selected from among melamine resins (E1) and blocked polyisocyanate compounds (E3).

13. The aqueous coating composition according to claim 10, wherein the curing agent (E) is at least one selected from among melamine resins (E1) and blocked polyisocyanate compounds (E3).

14. The aqueous coating composition according to claim 11, wherein the curing agent (E) is at least one selected from among melamine resins (E1) and blocked polyisocyanate compounds (E3).
